(19) United States
(12) Patent Application Publication
(10) Pub. No.: US 2020/0364817 A1
(43) Pub. Date: Nov. 19, 2020

(54) MACHINE TYPE COMMUNICATION SYSTEM OR DEVICE FOR RECORDING SUPPLY CHAIN INFORMATION ON A DISTRIBUTED LEDGER IN A PEER TO PEER NETWORK

(71) Applicant: UCOT HOLDINGS PTY LTD, Sydney (AU)

(72) Inventors: Ren Ping LIU, Sydney (AU); Xu WANG, Epping (AU); Guangsheng YU, Lane Cove North (AU); John BAIRD, Killara (AU)

(21) Appl. No.: 15/929,655

(22) Filed: May 14, 2020

(30) Foreign Application Priority Data
May 17, 2019 (AU) 2019901683
Aug. 23, 2019 (AU) 2019903089

(51) Int. Cl. G06Q 50/28; G06Q 30/00; G06Q 50/04; G06Q 10/10; H04L 9/32; G06F 16/23; G06F 16/27; G06K 7/14; G06K 7/10; H04L 29/08

(52) U.S. Cl. CPC G06Q 50/28; G06Q 30/0185; G06Q 50/04; G06Q 10/10; H04L 9/3236; G06F 16/2379; H04L 2209/38; G06K 7/1413; G06K 7/1417; G06K 7/10366; G06K 7/10297; H04L 67/104; G06F 16/27

(57) ABSTRACT

Disclosed is a method to secure supply chain data in a blockchain that includes retrieving a unique identification code from a tag of a product and generating digital statuses of the product in the supply chain; creating a transaction record comprising a payload field storing the unique identification code and the digital statuses; generating a hash of the transaction records and then encrypting the hash with a secured key; and sending the transaction record to a node in a blockchain network, in which the node has the transaction record verified and mine into a block for storing on a distributed ledger, thereby ensuring the transaction record tamper-resistance.

### CROSS-REFERENCE TO RELATED APPLICATIONS

This application claims priority to Australian patent application number 2019901683, filed ______, and Australian patent application number 2019903089, filed ______, the disclosures of which are incorporated by reference.

### TECHNICAL FIELD

This invention involves a machine type communication system or device for recording supply chain information on a distributed ledger in a peer to peer network. More specifically, the present invention provides an Internet of Thing (IoT) for detecting and recording supply chain information and storing the supply chain information on a blockchain.

### BACKGROUND

The International consumer market is highly competitive and growing in complexity over time. It allows consumer exposure to a larger variety of choice and more competitive prices. It aspires innovation of better and more cost effective products to the consumers, and reduces the risk of market control and monopoly. This drives greater requirements for more convenience, aspirations and desires to create alternative sales channels outside of the traditional retail options. Technology has played an increasing important role in these opportunities to drive all retailers and their suppliers to streamline costs, to improve the effectiveness of investment in innovation, and to optimise the performance to better delivery products to consumers.

The current state of the infrastructure of supply chain management is fragmented into offline and online components. This has led to misplacements of products and mismanagement of inventory because the supply chain management system is not transparent and requires integration. There are emerging solutions for supply chain management to allow the tracking of the products along the entire supply chain.

US Patent Application No. US20050177435 discloses a supply chain network. The customers, suppliers, logistics providers, carriers, and financial institutions are all connected to a centralized supply chain server. The supply chain server is central to a many-to-many relationship. Accordingly, the server is adapted to handle various management activities for each stakeholder of the supply chain, such as negotiating prices, terms and conditions, managing supply and demand, and maintaining transaction information. In the process, the supply chain server gathers significant amounts of relevant data and becomes a central repository for such information. Consequently, the supply chain server is adapted to utilize the data for the benefit of the members of the supply chain and others.

US Patent Application No. 2017/0331896 discloses a computer-implemented method for processing an asset within a supply chain includes: providing a first distributed ledger maintained by nodes within a first distributed consensus network; providing a second distributed ledger maintained by nodes within a second distributed consensus network; creating the asset by a supply chain first entity associated with at least one node within the first network, and providing a digital certificate uniquely associated with the asset for authentication; creating a first transaction record in the first distributed ledger representing an asset transfer and its associated digital certificate from the first entity to a supply chain second entity associated with at least one node within the first network; and creating a second transaction record in the second distributed ledge representing an asset transfer and its associated digital certificate from the second entity to a supply chain third entity associated with at least one node within the second network.

Although increasing traceability and data transfer in a food supply chain results in direct economic benefits, the implementation of a supply chain management system is difficult. Current solutions to tracing and capturing are constrained in technology capacity and cost of labour intervention.

Most of the time, the tracking records are more useful with less unreliable transport method for an already low-margin industry. A solution of IoT and Blockchain is able to trace and authenticate data for creating a historical record of products as it moves down the supply chain. One exemplary solution goes beyond the capture and recording of data to provide analysis and optimization to maximize freshness, minimize waste and environmental impact, and ensure a safer, more efficient food supply chain.

IBM Watson™ is a platform for connecting Internet of Thing devices. The current standard for Internet of Thing includes Sigfox™, LoRa, and Narrowband IoT. Devices following these standards are able to perform machine type communication for long range distance. However, none of them is adapted to communicate over 40 km. Hence, it would not be capable of handling tracking for long range transport, such as land transport in less developed areas, such as rural Australia or rural China where signal stations may usually be over 40 km apart, or air flight and sea shipping where it is impossible to have signal stations between ports. None of the prior art solution is capable of accommodating very long distance transportations, e.g. transporting products in Australia or China.

Satellite communication device and Cellar Network devices are able to handle a much long distance but they are less power efficient and costly. Using Satellite communication device and Cellar Network devices will greatly increases the costs of low cost products. As cost is not an object, the products can be transported on flights with secured and temperature controlled storage which will minimise the risk of tempering.

Hence, there is a need for a machine type communication system or device for recording supply chain information on a distributed ledger in a peer to peer network that can overcome or ameliorate the current physically limitations of the prior art.

### SUMMARY

### Problems to be Solved

The present invention relates to a machine type communication system or device for recording supply chain information on a distributed ledger in a peer to peer network.

One advantage of the present invention is that there is provide a machine type communication system or device to reconnect the supply chain by generating tracking history records of a product in order to promote transparency along the entirety of the supply chain. For example, if it is a fresh produce, the tracking process may start from the farm until it reaches the consumer.

By automating the processes for capturing and authenticating data along the supply chain, the MTC system of the present invention is adapted to assemble the historical records of products as they move through the supply chain.

It may be advantageous to provide an automating process for capturing and authenticating data along the entire supply chain.

It may be advantageous to provide an MTC system that is adapted to assemble and authenticate the historical records of products through the entire supply chain.

It is, therefore, may be an object of the present invention to provide a new and novel for computer system and method which provides.

Other objects and advantages will become apparent when taken into consideration with the following specification and drawings.

It may be an object of the present invention to overcome or ameliorate at least one of the disadvantages of the prior art, or to provide a useful alternative.

In a first aspect of the present disclosure, there is provided a method to secure supply chain data in a blockchain thereby ensuring tamper-resistance.

In another aspect, there is provided a method to achieve real-time tracking, monitoring, and traceability to reinforce supply chain security by employing IoT technology.

In yet another aspect, there is provided a method to achieve fine-grained supply chain data management by adopting radio-frequency identification (RFID) technology.

In yet another aspect, there is provided a method to automatically associate IoT event with products by combining IoT and identification tags.

In another aspect of an embodiment of the present invention, there is provided a method to collect and manage various supply chain data, including manufacturing data, transportation data, warehousing data and trading data, within a single system.

In yet another aspect, there is provided a method to integrate one or more distributed ledgers and databases and achieve secure, trusted and efficient supply chain management.

In another aspect, there is provided a method to secure supply chain data in a blockchain, wherein the method comprising the step of:

retrieving a unique identification code from a tag of a product and generating digital statuses of the product in the supply chain;

creating a transaction record comprising a payload field storing the unique identification code and the digital statuses;

generating a hash of the transaction records and then encrypting the hash with a secured key;

sending the transaction record to a node in a blockchain network, wherein the node has the transaction record verified and mine into a block for storing on a distributed ledger, thereby ensuring the transaction record tamper-resistance.

Preferably, the node is any one of a blockchain gateway or a normal node, wherein the blockchain gateway is adapted to forward the transaction record to a normal node for processing.

Preferably, the normal node is adapted to store all the blockchain data and connect to other blockchain nodes to form a peer-to-peer network.

Preferably, the blockchain networking comprises one or more block miner for storing all blockchain data and connect other blockchain nodes to form a peer-to-peer network, and wherein the block mine is adapted to receiving a transaction record, verifying the transaction records, generating a block to record on a distributed ledged in accordance with a consensus protocol, and writing the block on the distributed ledger.

Preferably, the blockchain networking comprises one or more light node adapted to store block headers and a plurality of latest blocks of the distributed ledge without all blockchain data.

Preferably, the digital statuses are generated by a reader associated with one or more sensor to measuring one or more conditions related to: time, humidity, temperature, light intensity or frequency, acceleration, pressure, location.

Preferably, the reader is associated with one or more sensor for interfacing into a packaging of a product to monitor the packaging integrity, or closure.

Preferably, the reader comprises a communication interface, a power source, a processing unit, and a controller, wherein the controller is adapted to associate with one or more sensors.

Preferably, the communication interface comprises a network stack buffer memories, analog-to-digital/digital-to-analog (AD/DA) converter, and a digital signal processing unit, such that the communication interface is adapted to support one or more network communication protocols including 802.11n, LoraWan, NB-IoT, RFID, BLE, SigFox, CAT-M1, NFC.

Preferably, the unique identification code is retrieved from a tag associated with a product, and the tag comprises any one of a one dimensional barcode label, a two dimensional barcode label, RFID tag, NFC tag, Internet of Thing tag, or a combination thereof for storing the unique identification code.

Preferably, the unique identification code is recorded in a database and stored on a tag associated with a product through a manufacturer software application.

Preferably, a tag is associated with a product during a manufacturing process of a production line of the product automatically.

Preferably, the database is adapted to store supply chain information of a product, wherein the supply chain data comprises one or more digital statuses generated by one or more readers.

Preferably, the supply chain data is mapped from the distributed ledger to a database in real-time by one or more software agents on a gateway node of a blockchain network.

Preferably, the software agents are adapted to loading rules and templates from local configuration files, remote configuration files, or databases to guide actions of the software agent, monitoring blockchain network statuses, parsing transaction records, writing and reading parsed data to and from the database.

Preferably, the database is adapted to store structured supply chain data and corresponding blockchain indexes.

Preferably, the method further comprising one or more smart contracts comprising one or more condition related to the digital statuses, such that when a digital status does not satisfy a conditions, a notification will be generated and sent to a stakeholder.

Preferably, the method further comprises the step of displaying tracking information by a user software application on a user device, wherein the user software application is adapted to retrieving a unique identification code from a product, compiling a tracking query of the product, sending the tracking query to a blockchain gateway, receiving transaction records from the blockchain gateway, and reconstructing a tracking history of the product.

In another aspect, there is provided a system for recording supply chain information on a distributed ledger in a peer to peer network, comprising:

one or more tags, each of which has a unique identification code corresponding to a product;

one or more readers comprising a communication interface, a power source, a processing unit, and a controller for associating with one or more sensors for generating one or more statuses;

an infrastructure comprising a server associated with a database and a blockchain network; and

one or more user software application;

wherein the readers are adapted to retrieve the identification code of the product and generate one or more status related to the product to compile a transaction record and send the transaction record to the server for uploading the transaction record to the blockchain network.

Preferably, each of the tags comprises any one of a one-dimensional barcode label, a two-dimensional barcode label, RFID tag, NFC tag, Internet of Thing tag, or a combination thereof.

### BRIEF DESCRIPTION OF THE FIGURES

FIG. 1 is a schematic diagram of a machine type communication system for recording supply chain information on a distributed ledger in a peer to peer network according to an embodiment of the present invention;

FIG. 2 is a schematic diagram of tag initiation process in manufacture plant of an embodiment of the present invention;

FIG. 3 is a flowchart diagram of a tag reading process of an embodiment of the present invention;

FIG. 4 is a flowchart diagram of the another reading process of an embodiment of the present invention;

FIG. 5 is schematic diagram of a reader of FIG. 1;

FIG. 6 is process flow diagram of reading a tag by a reader of FIG. 5;

FIG. 7 is a work flow diagram of an infrastructure of FIG. 1;

FIG. 8 is schematic diagram of a set up of the reader and the blockchain network of FIG. 1;

FIG. 9 is a workflow diagram of the set up the reader and the blockchain network in FIG. 8;

FIG. 10 is schematic diagram of another set up of the reader and the blockchain network of FIG. 1;

FIG. 11 is a workflow diagram of the set up the reader and the blockchain network in FIG. 10;

FIG. 12 is a schematic diagram of a blockchain network of FIG. 1;

FIG. 13 is a workflow diagram of an agent in accordance with an embodiment of the present invention;

FIG. 14 is workflow diagram of a user process of a user app of FIG. 1;

FIG. 15 is workflow diagram of the system of FIG. 1;

FIG. 16 is a schematic diagram of the tags of FIG. 1;

FIG. 17 is a user interface of the user app of FIG. 1;

FIG. 18 is another user interface of the user app of FIG. 1;

FIG. 19 shows other user interfaces of the user app of FIG. 1;

FIG. 20 is a dashboard interface of a manufacturer app in accordance with an embodiment of the present invention;

FIG. 21 is a product information interface of a manufacturer app in accordance with an embodiment of the present invention;

FIG. 22 is a smart tag interface, or tag and device interface of a manufacturer app in accordance with an embodiment of the present invention;

FIG. 23 is a traceability interface of a manufacturer app in accordance with an embodiment of the present invention;

FIG. 24 is a report interface of a manufacturer app in accordance with an embodiment of the present invention;

FIG. 25 is connection interface of a manufacturer app in accordance with an embodiment of the present invention;

FIG. 26 is company panel interface of a manufacturer app in accordance with an embodiment of the present invention.

### DESCRIPTION OF THE INVENTION

The present disclosure proposes a new system or device for machine type communication (MTC) for recording supply chain information on one or more distributed ledgers in a peer to peer network. The ledgers are duplicated in many distributed nodes.

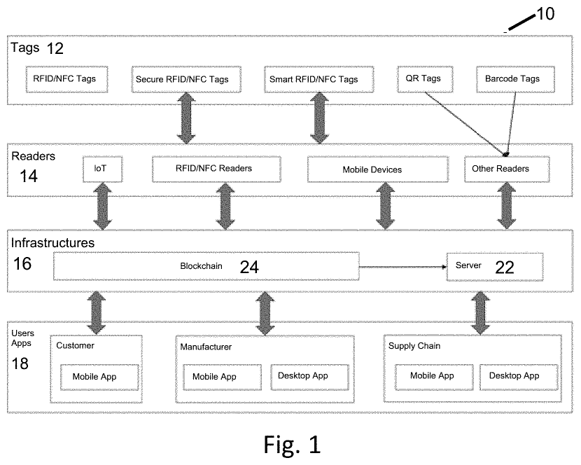

Referring to FIG. 1, the present invention also provides a system 10 comprising a plurality of tags 12 for identify the products, readers 14 that are able to reads the information on the tags, an infrastructure 16 to store and manage data collected by the readers, and user software applications (apps) 18 adapted to allow different type of users to access and manage the data stored in the infrastructure 16.

The system 10 herein described also enables applications other than supply chain management to be created from the data structure, workflow and processes behind the infrastructure of the embodiments of the present invention.

The tags 12 in the system of the present invention are designed to identify the products. Every tag 12 contains unique content. The unique content indicates its virtual identity within the system 10 and will be stored in the distributed ledgers. A tag 12 can be used to label a unique product, or a package containing a group of packages and/or products

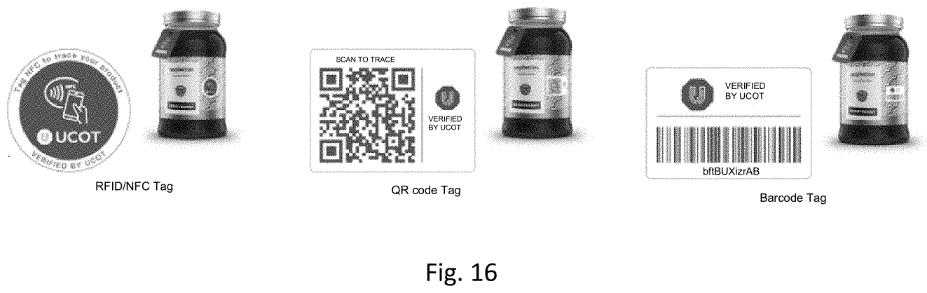

In one embodiment, each product is devised with an individual tag. In another embodiment, a bundle or batch of the products is devised with an individual tag. In one embodiment as shown in FIG. 16, the tag 10 is a passive identification tag such as barcode tag in which it has no ability to record information of the products or send the information out to a reader.

In this specification barcode includes EAN/UPC barcodes, omnidirectional databar, stacked omnidirectional databar, expanded databar, stacked expanded databar, one-dimensional barcode, and two-dimensional barcodes such as data matrix or QR code. The barcode tags are very low cost, easy to apply, and implemented.

In one embodiment, barcode tags can be utilized in cases where NFCs are not suitable. Barcode tags are initialized with a unique serial number compatible with the system 10 of the present invention. In many cases, this serial number is contained with a URL that may be utilized to access information related to the Barcode without the need for the app 18. These Barcodes may be printed in a variety of colours and sizes as required by the end user.

The major disadvantage for barcode tag is that they must be present on a visible surface for scanning. When the products with QR or barcode identification tags are packed inside a box, a reader cannot read those QR identification tags or barcode identification tags without unpacking the products with the QR or Bar identification tags from the box.

In another embodiment, the tag 12 can be a Radio-Frequency IDentification (RFID) tag or Near-Field Communication (NFC) tags, Barcode tags, where the RFID/NFC tags are mainly used due to their security and durability. In one embodiment of the present invention, the tag 12 is a RFID/NFC tag of a small, paper-thin tag adapted to store an amount of data and support data create, read, update and delete via wireless communication technologies.

The RFID/NFC tags can support various technologies. They can be simple tags that support a basic identification, or smart tags that are able to sense and store environmental data. The tags can also support various security technologies to avoid been attacked.

In one embodiment, the tag 12 comprises an antenna adapted to transceive electromagnetic wave, a microprocessor adapted to generate the identification code for the tag, and a substrate for holding the antenna and the microprocessor. In one embodiment where the tag 12 is a passive tag without internal power, the tag 12 receives radio waves from the transmitter and to convert electromagnetic wave into energy to power the chip.

In another embodiment, the tag 12 comprises an internal power source. The electromagnetic wave received by the antenna will wake the microprocessor and generate the identification code and the internal power source will power the transmission of the identification code to a longer distance.

In one embodiment, the substrate is adapted to have a barcode printed thereon such that a barcode reader may be used to read the tag 12 as well.

In one embodiment, the RFID/NFC tags are initialized with an electronic product code (EPC) compatible with the system 10 of the present invention. In many cases this EPC can store information about the type of EPC, unique serial number of product, its specifications, manufacturer information, etc. EPC makes it easier for companies to classify and distinguish individual product by making it effective to link it to system 10 and access through the apps 18.

The substrate of the tags 12 can be customized, both in terms of size and through printing, e.g., branding/logo. In one embodiment of the present invention, the tag 12 can be various RFID/NFC tags with different materials, shapes, and appearances according to specific requirements. The substrate of tags 12 can be made by different materials, e.g., paper, plastic, and metal, and other waterproof materials. This allows the tags 12 to be used in various applications and on many different types of packages.

Typically, RFID/NFC tags suffer from several risks. For example, the tags can be peeled off from the associated product and attached to a fake. Another example is the tag “clone attack” where the whole RFID/NFC tag contents are copied to other tags. In one embodiment, the tag 12 has an embedded password from the manufacturer such that when carrying out a challenge-handshake authentication protocol with the reader, the reader will be able to identify the authenticity of the tag. So long as the password is long enough, the manufacturer does not use the same password for all device, there is no way for an external reader to read the password, it is impractical for an intruder to crack the password with brute force.

In one embodiment, the tag 12 is a normal static RFID/NFC tags adapted to store static content. In another embodiment, the tag 12 is a dynamic tag comprising a microprocessor adapted to generate pseudo-random numbers and perform encryption according to predefined keys and an algorithm. As a result, the tag 12 is adapted to use a different encryption key each time they are read. The static content is dynamically encrypted and can only be decrypted by its owner, who knows the pre-defined keys and algorithm. Should attackers read the tag in an attempt to clone it, the image they obtain will at most be valid for one subsequent read.

In another embodiment, the tag 12 is a pseudo-dynamic tag which operates similarly to a dynamic tag, except instead of the algorithm being contained within the microprocessor of the tag, the algorithm is run externally and the tag is reprogrammed with a new code each time it is scanned.

In yet another embodiment, the tag 10 is a smart RFID/NFC tag which is equipped with sensors to support environmental sensing functions or other facilities. For example, some smart tags are able to sense and record environmental parameters such as temperature and humidity. These measurements are then stored in onboard memory for later retrieval.

In another embodiment, the tag 12 has a fragile substrate to prevent the “reattaching attack”. The substrate and the antenna of the tag 12 are fragile in construction and any attempt to remove them results in breaking the tag 12, such that the tag cannot be read any more once peeled off from the original surface. Moreover, the broken tag can serve as a tampered evidence.

Depending on the implementation, the user may select one or more of the identification tag to apply on the products. Any of the above types of tags can be used in conjunction to cope with different application scenarios.

In one embodiment, each of the identification tags is created in the system 10 prior to being deployed. This tag initiation process comprises the step of generating a unique ID for each item being tracked within the system10. Then, each unique ID and any of the corresponding information are encoded on a tag. Other information specific to the item may then be stored within the system or on the tag. In another embodiment, any electronic tags, such as RFID/NFC tags, can be recycled by deleting the old information and reprograming the new data on the tags.

In the tag initiation process for a small batch of tags, it is feasible to manually connect an item with the unique ID. When creating a tag within the system in this scenario, the associated information such as the product batch number, production date, expiration date, factory information, etc., can be manually entered and associated with the item through the systems web-based interface. This approach is only suitable for small and medium-sized businesses to trace the source of small quantities of goods.

The association process may also be integrated with production line, making the process automatic. A typical scenario is that the production line has one or more fixed readers 14 to read tags 12 on the production line and upload data to blockchain 24 one by one.

In particular, the association between an item and the unique ID can be automatically established during the production process of the items. In the production line, the manufacturer may equip the automatic assembly line with customization equipment and background link system. The customization equipment and background link system are adapted to automatically obtain from the inventory database 26 the relevant information such as the product batch code, production date, expiration date and so on into the smart label, and then read the product smart label for the information upload blockchain process. The association process can be completed in time in the manufacturing process of the commodity and is suitable for large enterprises with mature commodity production lines.

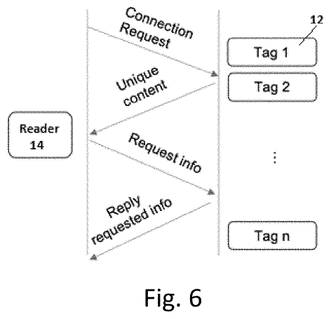

In another embodiment, the readers 14 can associate a batch of tags automatically via scanning technology as shown in FIG. 6. The readers 14 first broadcast a connection request. The tags 12 that receive the broadcasted message can return their unique content. The readers can also request information from a specific tag according to the unique content. The tags owning the unique content can then return the requested info. In this way, readers can aware the connected tags and then can map the IoT data to connected tags.

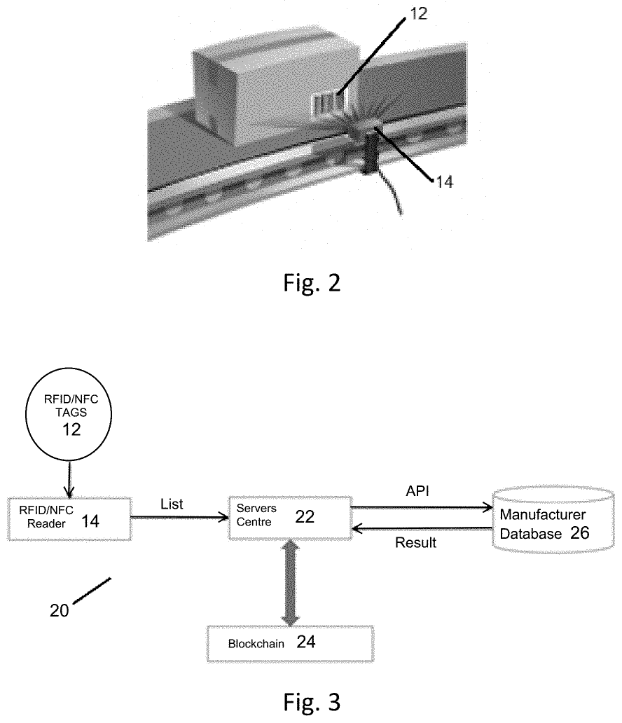

The reader 14 can be installed in many locations. In one embodiment, the reader 14 is installed in the manufacturing plant of the items to be tagged. A suitable reader 14 (barcode reader, QR code reader, RFID/NFC tag reader) is placed in position beside the existing machinery used to label products with a manufacturing date, batch number, and expiry date. As the product passes by the reader 14 as shown in FIG. 2, the reader scans the product and picks up the unique identification number from the tag. The reader 14 sends this unique ID, along with the production information to the servers 22 of the infrastructure 16. These servers 22 then initialise block records within the blockchain 24 with the received information.

In one embodiment, the reader 14 is adapted to carrying out a tag reading method comprising the steps of reading an identification number along with other information from the tag, such as an RFID/NFC tag, or barcode label. The reader 14 then sends the identification number and other information received to one or more servers 22. The server 22 then invokes the application programming interface (API) to the database 26 to obtain a search result from the database. Depending on the implementation, the API carry out the process of reading the inventory information and/or recording the identification information to the database. The server 22 then secure the information on the blockchain 24.

In one embodiment, the server 22 is adapted to prepare the transaction data for storing on the blockchain 24. The server 22 is adapted to receive the identification number from the reader 14. The server 22 will also record the time stamp for this record. The server 22 then invokes the API to read the inventory information from the inventory database 26. Optionally the server 22 packages the identification number, timestamp, inventory information into a record and passes the record through an authenticity algorithm to produce a hash or digital signature for the record. The server 22 then invokes the API for recording the hash or digital signature on a distributed ledger. This can be a private distributed ledger or public distributed ledger. The once the hash or digital signature is recorded on the server 22 is adapted to receive a blockchain address, transaction hash, and block number. The server 22 then invokes the database API to store the record, the record has or digital signature, the blockchain address, transaction hash, and block number in the database 26. In this way, the infrastructure 16 can limit the size of the data to store on the blockchain while allowing the database 26 to store a much larger amount of data.

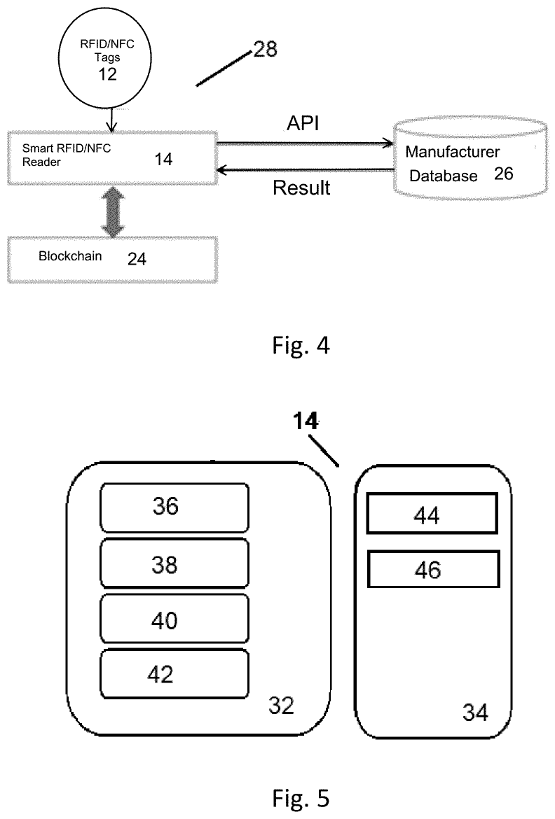

In another embodiment as shown in FIG. 4, the reader 14 is adapted to carrying out a tag reading method comprising the steps of reading an identification number along with other information from the tag, such as an RFID/NFC tag, or barcode label. The reader 14 then invokes the application programming interface (API) to the database 26 to obtain a search result from the database. Depending on the implementation, the API carry out the process of reading the inventory information and/or recording the identification information to the database. The server 22 then secure the information on the blockchain 24. As the reader 14 in this embodiment is adapted to carry out some of the functions of the server 22, a smart RFID/NFC reader is required.

In one embodiment, the smart RFID/NFC reader 14 comprises a base module 32 and a wiring harness 34. The base module comprises a communication interface 36, a power source 38, a processing unit 40, and a controller 42.

The communication interface 36 is adapted to support network standard protocols, such as 802.11n, LoraWan, NB-IoT, RFID, BLE, SigFox, CAT-M1, NFC. In one embodiment, the communication interface 36 comprises a network stack buffer memories, analog-to-digital/digital-to-analog (AD/DA) converter, and a digital signal processing unit.

The power source 38 comprises a battery and a power management co-processor. The battery is preferably a rechargeable battery. The power management co-processor is responsible for the all power related activities, such as interrupt handling, managing the batteries, providing power to the reader 14 including sensors, removing power from devices not being used and putting the unit into a deep sleep status, as well as waking it up when required. In one embodiment, the power source comprises a separate back-up battery for system timer such that the system time will keep running even the main power is down. In another embodiment, the reader 14 is adapted to record the power level of the power source 38 and send it to the server 22. The server 22 may calculate the expected power required for the supply chain process and alert the manufacturer to replace the batteries.

The processing unit 40 may comprise a microprocessor adapted to run the firmware and software, static memories, and non-volatile memories adapted to store system operating code and data. The processing unit 40 has separated buffer memory to store temporary data for processing. In one embodiment, the processing unit has a digital signal processing. In one embodiment, the processing unit 40 comprises a Field Programmable Gate Arrays (FPGA) processing unit programmed to handle the hashing and digital signature functions.

The controller 42 comprises a microcontroller, AD/DA converter, DSP unit, firmware and software for managing the various sensors. Preferably, the reader 14 is adapted to have a wide range of sensors plug-in. These sensors may include: location sensor, GPS, accelerometer, sensor, thermometer, hydrometer, barometer, photometer, etc.

The wiring harness 34 comprises a standalone device with basic functionality, and the wiring harness which contains the device-specific sensors, Device ID and an amount of non-volatile memories. Preferably, the wiring harness 34 comprises an AD/DA converter, an FPGA processing unit, and a DSP unit. The functionality of the wiring harness may include sensing the presence of water, particular gas concentration, touch, tamper, and status of packaging by monitoring the integrity, closure of the packaging.

In one embodiment, the reader 14 comprises a standard interface, such as SmartBus, which is used to attach to the items being monitored via a wiring harness. This harness may contain more than just passive wires.

In another embodiment, the reader 14 comprises a high-performance microcontroller, supporting multi-threads processing, internal antennas, power management and so on. This enables the readers to process data at high speed yet maintains low power consumption. Together with a large RAM and Flash memory, the reader 14 can internally store a large number of messages when facing situations without network connectivity. In one embodiment of the present invention as shown in FIG. 5, the reader 14 is adapted to format the data and timestamp into transaction records, authenticate the transaction records using hash functions or digital signature function, and then send the authenticated block directly to a private or public distributed ledger. In one embodiment, the processing unit 40 comprises an FPGA processing unit. The FPGA is pre-programming to perform the hash function, digital signature function, and/or encryption functions All stages of the data path are either on our managed server, or use encrypted communications for security and data integrity

In another embodiment, the reader 14 is a mobile device with an Android or Apple iOS mobile application which can be installed on an android phone or Apple iPhone with NFC or camera capabilities . The mobile application adapted to carry out the functions of: Authentication, Scanning products, and Sending data for blockchain transaction. The Authentication function is adapted to identify each object of the system 10. Scanning product function is adapted to allow Employee using the mobile application to gather unique ID associated with the object. The unique ID will be processed on the mobile device and wait to be uploaded to the blockchain. The Send blockchain transaction function can be performed when the mobile devices have access to the Internet and send information such as the product location, product details and employee information or the authenticated code thereof to the blockchain through the Internet. From there the tracking information will be stored in the blockchain and can be displayed when needed.

One of the readers 14 of the present invention is adapted to collect environmental data and map into tags. The key to this is setting up the correlation between readers and tags. The readers 14 can interact with tags in many ways.

In one embodiment, the unique ID of tags 12 can be hard-coded into readers 14 directly. This scheme has limitations and would only be used when the readers 14 have specific service targets. For example, in the high-value targets.

Operators can use tag reader 14 to read the unique content of tags one-by-one and then load the additional information into the reader. This information is then sent to the servers 22 to initialise the item in the blockchain 24.

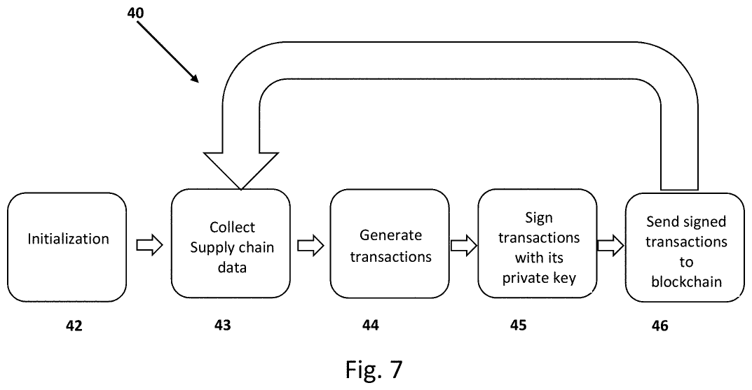

Reference is now made to FIG. 7 showing the process 40 of recording the data on the blockchain 24 carried out by the infrastructure 16 of an embodiment of the present invention. The process 40 comprising the steps of initialisation 42, collecting supply chain data 43, generating transaction records 44, signing transaction records 45, and sending transaction records to the blockchain 46.

In the step of initialisation 42, the data source owner creates a blockchain account, i.e., a pair of private key and public key, for a single data source. The owner then transfers a number of blockchain tokens to the blockchain account for further transaction fees. The owner configures the data source. Specifically, the private key is copied to the data source, and the address of a blockchain gateway is configured to the data source. The corresponding blockchain address, derived from the public key, is registered in the database in the form of rules.

In the step of collecting supply chain data 43, the data sources identify materials in supply chain and senses their conditions which are encoded into supply chain data. For example, readers 14 in cold chain transportation collect records of GPS location and temperature.

In the step of generating transaction records 44, the data sources and the supply chain data are used to generate a block of payload data for storing in a payload field of a transaction record. In this step, the supply chain data are first organized according to predefined templates.

In the step of signing the transactions records 45, the data sources generate the hash of the transactions and then encrypt the hash by using their private keys. The encrypted data are attached to the end of the transactions as the signatures of the transactions.

In the step of sending signed transaction records, the data sources can either send the transactions to blockchain gateways via the APIs provided by the gateways or directly send the transactions to connected blockchain nodes. The gateways forward collected transactions to other blockchain nodes. In this step, the server gateway is adapted to mine blocks, wherein miners in the blockchain 24 collect transactions, verify the transactions and then mine the transactions into blocks. Any transactions that do not have the correct signatures are rejected by the miners. Various mining algorithms and consensus protocols can be employed in the proposed system.

In one embodiment of the present invention, there is a provided a reader 14 adapted to gather sensor data into the payload of transaction records, then sign the transactions. These signed transaction records then get uploaded to the blockchain via a communications gateway. In this method, the gateway simply buffers and passes through pre-signed blocks of data.

In this method the signing of the data is performed by the reader 14 prior to transmission. Signing the data before it leaves the readers 14 requires more processing power on the readers, which will impact battery life, but ensures the highest level of trust in the information committed to the blockchain.

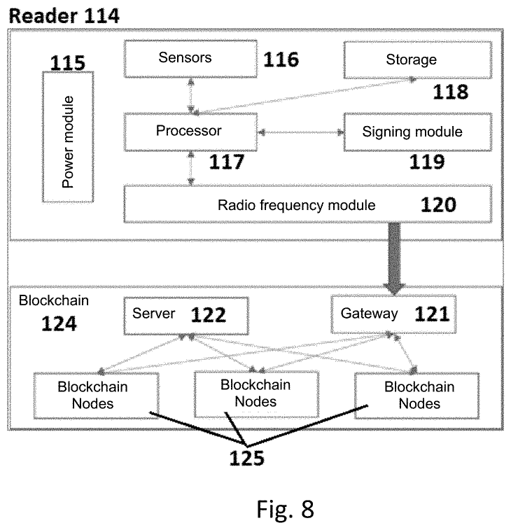

FIG. 8 shows a schematic diagram of a reader 114 of an embodiment of the present invention. The reader 114 comprises a power module 115, sensors 116, processor 117, storage 118, and radio frequency module 120. The readers 14 can also have a signing module 119 which can be an independent chip supporting signing algorithm, or it can be a part of the main processor.

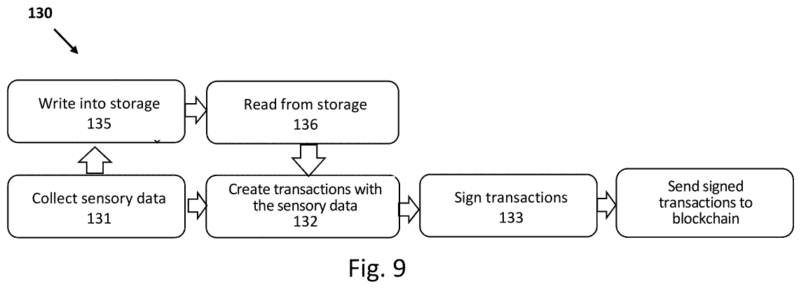

The process 130 carried out by the reader 114 is described with reference to FIG. 9. The process 130 starts with the step of collecting sensors data 131. Typical sensors data includes information such as location, temperature, light, humidity, acceleration, altitude, pressure, and speed. This is done by the sensors embedded in the reader 114 or associated with the reader 114.

The reader 114 then carries out the step of creating transaction records 132 having payloads contain the sensor data. In one embodiment, the transaction record format follows the blockchain standard. This is performed by the processor 117 in the reader 114. The reader 114 then carries out the step of signing the transaction record 133 by employing the signing module 119. The reader 114 has a pre-programmed private key stored in the memory signing these transaction records. Once signed, the reader 114 sends the signed transaction to the blockchain via the radio frequency module 120 in step 134, where a blockchain gateway 121 buffers them. The signed transaction record is then broadcast to all the nodes 125 in the blockchain network 124 by the blockchain gateway 121 and then mined into a block by blockchain miners.

The collected sensor data can also be saved to the onboard storage first as shown in step 135. Transaction records can then be created from the sensor data saved in the storage. This allows data to be gathered while the device cannot reach the blockchain in step 136.

In another embodiment of the present invention, the reader 14 posts data a-server 22 which package data into transaction records, signs the data on behalf of the reader, and broadcasts the transaction records to the blockchain network. In this method, the signing is performed by the server 22.

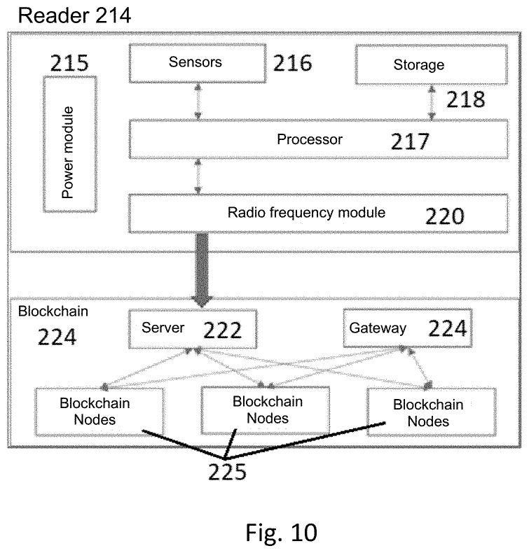

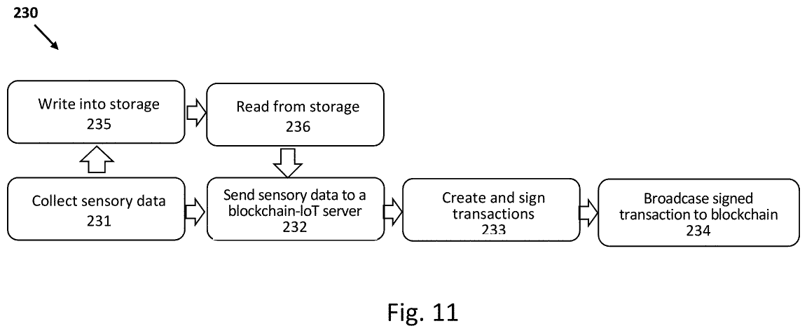

FIG. 10 shows a schematic diagram of a reader 214 of another embodiment of the present invention. In this embodiment, the data is signed by the server 222 on behalf of the reader 214. This requires less effort on the part of the reader 214, resulting in less battery consumption, but does require a high degree of trust between the readers 214 and servers 222, as well as trust in the communications network in between is secured.

Compared with the embodiment described in that using reader 114, the reader 214 does not have a signing module 119 and therefore is not adapted to create and sign transaction records. This function is served by the servers 222 in the blockchain 224. The servers 222 perform a method comprising the steps of:

receiving data from readers 214, in which the data transmission can be over various protocols, e.g., UDP or TCP, and HTTP;

creating and signing blockchain transaction records having payloads of the received data; and

connecting blockchain nodes 225 and broadcasts transaction records to the blockchain network 224.

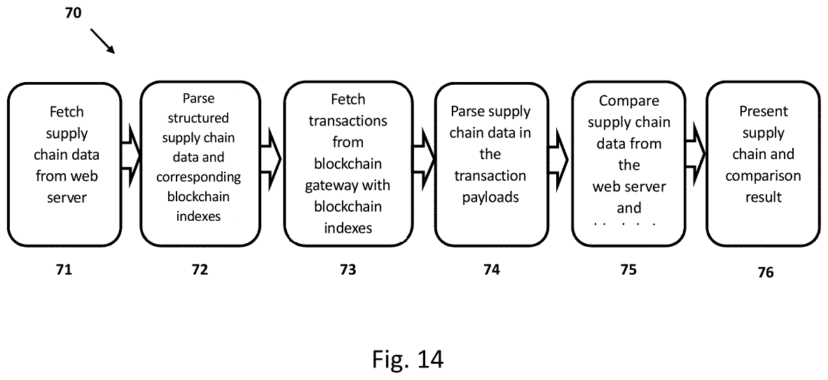

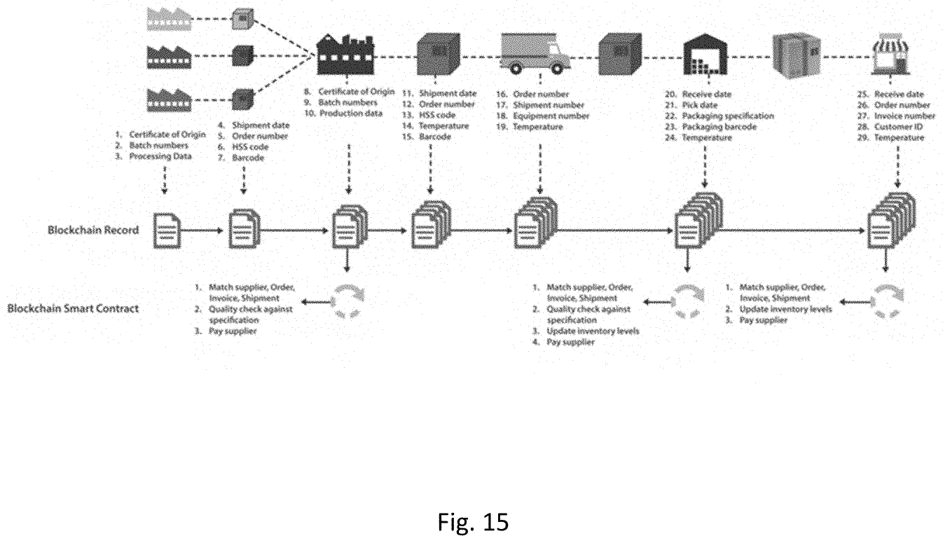

Reference is now made to FIG. 14, which provides a method of data uploading 230 carried out by the reader 214. The method 230 comprises the steps of collecting sensor data 231, send sensor data to a blockchain server 232, creating and signing transaction records 233, and broadcasting transaction records 234.

The process 230 starts with the step of collecting sensor data 231. Typical sensor data includes the location, temperature, light, humidity, acceleration, altitude, pressure and speed. This is done by the sensors in a reader 214 or associated with the reader 214.

The reader 214 can then carries out the step of 232 by sending sensor data to a blockchain server 222. This is done by the processor 217 and the radio frequency module 220 in the reader 214.

Optionally, the collected sensor data can also be saved to the storage as in step 235 and then sent to the server 222 later, when communications permit.

The server 222 then creates transaction records having payloads of the received data and then signing the transaction records in step 233.

The signed transaction records are then broadcast to all the network and then mined into a block by blockchain miners in step 234.

General blockchain platforms, e.g., Ethereum, Hyperledger, Bitcoin, and EOS, can be used as the blockchain infrastructure 16 in the system 10 in accordance with an embodiment of the present invention. Blockchain 24 is a distributed ledger running in a peer-to-peer network comprising blockchain nodes 25. Every blockchain node has a copy of the whole blockchain. The blockchain data is a series of blocks chained with their hash values. Every block contains a batch of transactions.

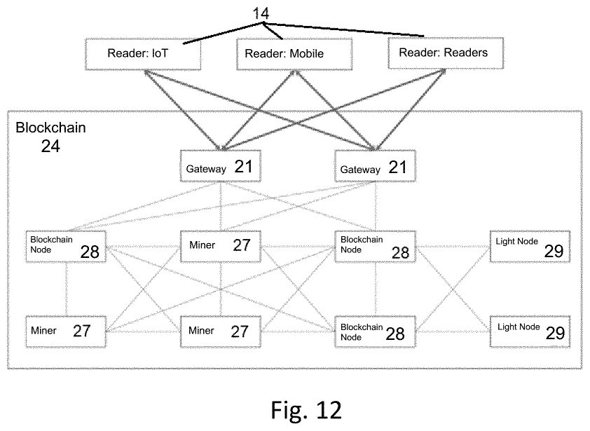

The blockchain network or system 24 is now described in more details with reference to FIG. 12. In one embodiment, the blockchain system 24 comprises four types of nodes 25. These are the gateways 21, block miner 27, normal nodes 28, and light nodes 29. Preferably, these nodes 25 have the ability to verify transactions and blocks, including their format and signatures.

The block miners or miners 27 are adapted to store all the blockchain data. The block miners 27 are adapted to connect other blockchain nodes 25 to form a Peer-to-Peer (P2P) network. The block miners 27 also collect transaction records and generate blocks. During the block generation, the block miners 27 are adapted to verify the transaction format and transaction signature. These block miners 27 also are also adapted to run a consensus protocol to reach consensus, and generate blocks, with other miners.

The normal nodes or blockchain nodes 28 are adapted to store all the blockchain data in a distributed ledger and connect to other nodes 25 to form a P2P network. The blockchain nodes 28 is adapted to verify the authenticity of any individual block on the distributed ledger.

The Blockchain gateways or gateways 21 are special blockchain nodes adapted to provide blockchain querying and block/transaction forwarding service to entities not in the blockchain or blockchain network 24. The querying and forwarding services can be realized over popular internet protocols, e.g., TCP/HTTP, UDP/HTTP, or QUIC. The gateways 21 are also adapted to connect other blockchain nodes 25 to form a P2P network.

The blockchain light nodes or light nodes 29 do not store the entire blockchain data or distributed ledger. These light nodes 29 are adapted to carry out the function of keeping block headers and the latest blocks, to reduce the chain data storage. Light nodes 29 are adapted to connect to a limited set of blockchain nodes 25.

The blockchain system or network 24 are adapted to carrying out the one or more processes of: maintaining P2P connection, verify transaction records and blocks, manage transaction records and blocks, mining blocks, and blockchain querying and forwarding.

The process of maintaining P2P connection allows block miners 27, normal nodes 28 and gateways 21 to maintain the connection with other blockchain nodes 25 through handshaking and routing protocol. The process includes node discovery, connection maintenance, transaction and block forwarding, load-balancing, etc. This process may be assisted by or delegated to networking devices such as secure gateways, routers, switches, and dedicated network servers.

The process of verifying transaction records and blocks is one of the preferable functions of all blockchain nodes 25. The process is adapted to verify received transaction records and blocks. The verification process includes format verification, signature verification, and consensus verification. Illegal transactions and blocks which fail to pass the verification will be dropped and an error code will be returned.

The process of managing transactions and blocks is another preferable function of all blockchain nodes 25. This process allows the nodes 25 to store transaction records and blocks persistently and manage them.

The process of mining blocks is only carried out by block miners and is adapted to carry out a proof-of-work function or protocol. The block mining process includes transaction verification, block verification and block generation. Every block contains a hash of its previous block.

The process of blockchain querying and forwarding services is preferably one of the main functions of the gateways 21, which is adapted to provide general APIs of the blockchain querying and forwarding services. Other devices may call the APIs to check key information of the blockchain, e.g., block height and account state, and send signed transactions to the blockchain.

In another embodiment, the readers 14 is adapted to carry out the function of nodes 25. In the event that readers 14 cannot reach the Internet but able to discovery nearby readers, the readers 14 can form its own distributed network for authenticating and storing authenticated data during downtime. This will ensure that the readers 14 keep tracing records without Internet connectivity. The reader to reader communication can be performed using any protocol available to the readers such as BLE. Once the Internet connection is restored, the readers 14 can flush the temporary authenticated information to the infrastructure 16 to store in the database and blockchain 24.

The server 22 of the infrastructure 16 of the system 10 as shown in FIG. 1 comprises at least any one or more of an agent, a database, and a web application server. The server 22 can also contain network service servers, e.g., name server, load balance server, backup server and content distribution network server, etc.

The agent in the server 22 of an embodiment of the present invention is a software that is adapted to retrieve blockchain data from the blockchain gateways, parses various supply chain data, and writes the parsed data into a database. The agent is also adapted to map supply chain data from a distributed ledger to a database in real-time.

In one embodiment agent is adapted to carry out the process of: loading templates and rules, reading transactions, reading transactions, storing and retrieving data to a database.

In the process of loading templates and rules, the agent is adapted to invoke one or more subroutines to load rules and templates from local configuration files, remote configuration files, or databases. Rules are used to guide the agent, e.g., from which block to start. The templates define the format of valid supply chain data. The data that does not follow the format will be filtered out.

In the process of reading transactions, the agent is adapted to invoke one or more subroutines for monitoring the state of blockchain 24. Specifically, this subroutine is adapted to run in the background or is a daemon for listening new blocks through blockchain gateways 21 and checks whether there are transactions packed in the blocks.

In the process of parsing transaction payload, the agent is adapted to invoke one or more subroutines to parse new transaction records. For every transaction record, the agent is adapted to first unpack the record, and extract the sender and payload from the record. The agent is adapted to check whether the transaction is a supply chain transaction by comparing the sender and payload with the loaded rules. For example, only transactions from authorized blockchain addresses will be further processed. The agent is also adapted to parse the payload recording supply chain data and obtain structured supply chain data according to the loaded templates.

In the process of storing data to and retrieving data from the database, the agent is adapted invoke subroutine to store parsed data into the database, or retrieve stored data from the database. The writing rules, e.g., the names of the tables and the columns, are defined in the templates.

The database in the server 22 of an embodiment of the present invention is an organised collection of data that are stored and accessed electronically by the associated database management system, e.g., MySQL. The database is adapted to store structured supply chain data, including identities in the supply chain, their description, their relationships and their activities. The database is also adapted to store the blockchain index of every record.

The database of the server 22 of an embodiment of the present invention is adapted to store structured supply chain data and the corresponding blockchain indexes.

The structured supply chain data is stored in multiple relational tables of the database. In another embodiment, the supply chain data is stored as objects in an object database. The structured supply chain data can have different data types, such as binary, text, asci, long integer, etc. The tables, including names and structures, are defined in templates. For example, a blockchain table can have columns of product id, locations, temperature and timestamp. The supply chain tables, as well as templates, can be customized according to specific requirements. Every supply chain data table has fields of blockchain indexes, e.g., sender's address, block number, transaction index in blocks, transaction hash. These blockchain indexes are used to accelerate the blockchain querying.

The database may comprise a blockchain index table storing the working process of the agent, e.g., the number of processed blocks.

In one embodiment, the database of the server 22 comprises a database management system which provides API for writing and querying data. The writing and querying APIs can be invoked by external applications. The supply chain data can only be inserted by authorized agents. In one embodiment, update and delete operations are disabled or denied for data integrity. The querying service supports SQL language for rapid implementation.

The web application server in the server 22 of an embodiment of the present invention is a software adapted to reading data from the database, providing API services, and web application services. The web application server can be accessed by mobile applications, and desktop applications for different stakeholders such as consumers, manufacturers, supply chain parties, and logistics service providers. In one embodiment of the present invention, the web server application implements supply chain querying APIs for application.

The web server application may comprise data querying client program for assigning a database role allowing to read and query data from the database. The data querying client interprets the client request into SQL language in the database.

In one embodiment, the web server application may comprise a web service program for providing an objected-oriented web-based interface to a database providing various Application Program Interfaces (APIs) to support different activities, e.g., retrieving trace information and checking product information. Additional features can be added according to business requirements. The APIs are implemented in popular web/mobile format, e.g., JSON-based restful HTTP APIs.

In one embodiment, the web server application may comprise service program APIs for supporting different activities, e.g., retrieving trace information and checking product information. Additional features can be added according to business requirements. The APIs are implemented in popular web/mobile format, e.g., JSON-based restful HTTP APIs.

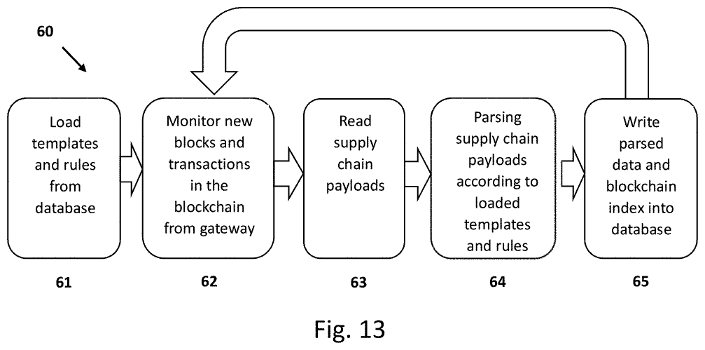

Refer is now made to FIG. 13 which shows an agent process 60 of the agent of the server 22 in an embodiment of the present invention. The process starts with an agent initialisation step 61 wherein an agent loads templates and rules. The templates and rules can be stored as configure files on the agent or stored in the database. The rules are adapted to assist selections of transactions to be mapped and are given according to the identities of data sources. The templates give the format of the payload in transactions. The agent connects to blockchain gateways 21 according to this configuration, i.e., the FQDN or IP addresses, and port numbers of the blockchain gateways.

In step 62, the agent is adapted to monitoring new blocks and transactions in the blockchain 24 from gateway2l. The agent monitors new blocks, as well as new transaction records in the blocks, by using the blockchain querying service provided on the blockchain gateway 21. The agent then parses transaction records in the blocks. Note that the transactions that have not mined into blocks, i.e., unconfirmed by the blockchain, will not be processed by the agent.

In step 63 and step 63, the agent is adapted to restore structured supply chain data from the transactions. In step 63, the agent selects the supply chain transactions according to the loaded rules. The agent then obtains the payload from the transaction according to the fixed blockchain transaction format. In step 64, the agent parses the payloads according to loaded templates and obtains structured supply chain data.

In step 65, the agent is adapted to write structured supply chain data and their blockchain index into a database. The agent is adapted to write the structured supply chain data and their corresponding blockchain index, including block number, transaction index in block and transaction hash, into a database. The agent is assigned the insert privilege of the database.

Reference is now made to FIG. 14 showing a process 70 for user apps 18, to accessing the blockchain-based supply chain service through mobile apps and desktop apps. In this invention, a user includes, but not limiting to, customers, manufacturers and third parties in the supply chain.

The process 70 commences with the step 71 of retrieving supply chain data from the web server. In this step 71, the user's commands are first translated into web API calls and sent to the web server by the user app 18. After receiving the API calls, the web server builds corresponding SQL querying commands and queries the database with the commands. The web server then creates API responses based on the querying result, including the structured supply chain data and blockchain indexes, and sends the responses to the application.

In step 72, the user app 18 carries out the process of parsing supply chain data and blockchain indexes, including but not limited to the responses and obtains structured supply chain data and blockchain indexes.

In step 73, the user app carries out the process of fetching supply chain transactions from the blockchain: The application fetches raw supply chain data transactions from gateways according to the obtained blockchain indexes. The gateways query requested transactions with the blockchain indexes provided by the application. The gateways return the transaction to the application after checked the corresponding blockchain data.

In step 74, the user app 18 carries out the process of comparing supply chain data from the web server and blockchain. The user app 18 parses the transactions and obtains the blockchain secured supply chain data. The user app 18 compares the parsed supply chain data and the supply chain data from the web server.

In step 75, the user app 18 carries out the process of presenting supply chain data and comparison result. The user app 18 presents the supply chain data to the user. Specifically, if the supply chain data from the web server comprises data in the blockchain, the supply chain data can be presented as certified by blockchain 24. If the two pieces of data are in conflict with each other, the user app 18 will notifies the database to check the data integrity.

In one embodiment the user app 18 is a mobile app which can be Android app, iOS app and, other apps. Consumers can use the user app to conduct product identification and traceability. The authentic traceability information includes product thumbnail, product name, global unique code, current time/position, product detail information interface, number of times of authenticity, first time verification/position, first time of verification, manufacturer/distributor, commodity origin, production batch, expiration time, commodity temperature record, blockchain depth traceability, product traceability map, detailed node information.

The user app is adapted to allow consumers can provide real-time feedback on products and system 10, and consumer feedback will be pushed to the back of the merchant system to help the merchants directly obtain consumer feedback and will also help consumers to conduct potential product identification. The user app may regularly receive advertisements, discount information, etc. that the merchant pushes through to the user app.

In one embodiment, the user app 18 is a manufacturer app for allowing a manufacturer to store product information in the system 10 and upload the information to the blockchain 24. In this case, the manufacturer app may be a mobile app, desktop app, or a manufacturer interface on the user app 18. The information includes the product name, product attributes, product manufacturer, product thumbnails, and product introduction links (customers can add and adjust themselves).

The manufacturer app is adapted to allow a customer to customise the traceable smart tag according to the requirements. The manufacturer app is also adapted to obtain supply chain problem alerts (including issues such as stock picking, delays, theft, etc.) and consumer feedback by fetching relevant event objects from a stack or having the server to push the relevant event objects to the manufacturer app.

In another embodiment, the manufacturer app is adapted to search and retrieve consumer portraits and related product data reports to help manufacturers save money in marketing and purchasing raw materials. The manufacturer app may able to extend commercial traceability in system 10 by building traceability nodes. Nodes may include, warehousing, logistics, quality inspection, customs, distributors, retailers, and the like. These function of the manufacturer app can assist manufacturers to expose to more business opportunities and partners within the system. In one embodiment, all merchants entering the system have passed strict audits and are equipped with system certification.

In one embodiment, the manufacturer app is adapted to allow manufacturers to order tags 12. The manufacturer app can receive information from manufacturers during ordering which will be used to pre-initialise the product on the blockchain. This information received in this process comprises:

product information, such as: product name, batch number (if it is applicable), make information (if it is applicable), date of manufacture, date of expiry and factory address;

package information, such as level specification, parcel name, tag category and quantity;

customised tag cover information, including height, width, picture and cover type (round or rectangle); and

shipping receiver contact information, including receiver name, contact number, address and postcode.

Tag suppliers are responsible for producing and initializing tags (that is, writing identifications into the tags). Manufacturers are responsible for physically associating tags with products, such as attaching the tag to the products. This can be achieved manually or automatically during the production process. By associating tags with products, tags and products can be logically linked during this process by uploading connection information to the server 22 of an embodiment of the present invention. If the tag attachment process is automatic during the production process, the logical linking can be achieved by correlating timestamp or other values that shared between them.

The user apps, including the manufacturer app, supply chain app, and customer app are adapted to upload transaction records on the blockchain 24. These three elements are responsible for uploading different information onto the blockchain. The manufacturers are responsible to physically connect tags to products, the association information will be uploaded to the blockchain in the form of transactions through the manufacturer app. Also, the manufacturers are responsible for uploading the very first tracking record of the product. The supply chain app is adapted to track every element in the supply chain contributing to the tracking record. The tracking record will be held to the blockchain 24. The customer app is adapted to record customers' location, product received time and some user information will be uploaded to the blockchain 24.

Uploaded transactions will be queued to be mined into blocks on the blockchain. The agents of the server 22 are adapted to keeping watching the events on blockchain 24. Any new transaction records will be captured and checked in terms of the uploader authentication, data format and the registration of the product. Only data that passed checking process will be stored in the database. Users can use the user apps 18 to fetch data from database and blockchain 24 when requesting tracking information.

In one embodiment, smart contracts are used in the supply chain transactions using the blockchain 24 of the server. Smart contracts are adapted to disrupt existing supply chain processes related to contract management. In one embodiment of the present invention, the system 10 is adapted to use smart contracts coupled with artificial intelligence (AI) for multi-party secure transactions. The automation and efficiency of smart contracts in our ecosystem allow for a water-tight process based on rules and variables that either activate or deactivate a contract. The reader 14 and other scanning devices, together with payment gateways, provide the system 10 with real-time information and depending on whether this information falls within the parameters set or not determines as to whether the next contract in the chain gets approved. It also determines if the goods are to continue with their journey, or be offloaded or returned. It can also de-activate contracts in the event of goods being damaged and it can automatically activate insurance against the third-party distributor responsible. The smart contract may then generate new orders and transport, warehousing and shipping logistics and payment contracts for a manufacturer to replace an existing order.

In a preferred embodiment of the present invention, smart contracts are implemented by cryptographic calculations that ensure the accuracy and security of the blockchain 24. These calculations are made by the combined computational power of the networked machines run by the nodes 25 of the blockchain 24.

Preferably, the smart contracts can be uploaded to the manufacturer desktop portal. In one embodiment, the smart contract is set up by the process comprising the steps of the user app may ask the user to input a number of rules for all variable types on each reader 14 or tracking device. Rules around the transportation, Insurance and payment related to the distribution of a product are attached to the details of each shipment and these rules will specify which devices, e.g. NFC/RFID reader 14, are assigned with reporting responsibility and on which variables to report, and how often, where, and which those variables are to be considered together with agreed rules. Once the smart contract is set up, it will be uploaded to the blockchain 24.

If no rules are broken, the smart contracts are activated. If a rule is broken the smart contract is either instantly deactivated, and/or an alarm is sent for the manufacturer to manually de-activate in the system. This will create a knock-on effect and deactivates all other contracts related to that contract either instantly, or when an alarm is sent to action this manually at the manufacturer level. The desktop interface of the user app 18 is adapted to allow users to set the parameters of what constitutes a valid and an invalid contract by inputting variables and their corresponding rules.

In one example of an embodiment of the present invention, the system 10 comprises reader 14 as the reporting device which is adapted to measure temperature, with temperature and GPS Sensor. Through the user app 18, the user set up a stable temperature parameter for the product to a range between: 10 degrees Celsius and 15 degrees Celsius. The user may set up an event for the product being under or above the stable temperature parameter such that an alarm will be sent to the manufacturer and third-party distributor simultaneously. Once the event is triggered and alert is sent, the system 10 may proceed to check the next condition, that checking the rectification of the problem. For example, the third party is then given x number of hours to rectify the problem, where the manufacturer specifies the number of hours in advance. If the problem is not rectified within the agreed time frame from first alarm then this instance can introduce a second and third alarm or immediately deactivate a contract, activate insurance on the shipment, cancel payment to a bank for that shipment, and/or re-order shipment from factory/warehouse.

In one embodiment, there are four basic types of visibility of smart contract variables both internally and externally with relevant third parties. The public functions or variables that can be called internally or through messages/alarms. The private variables and functions are only available to the current contract and not derived contracts. The internal functions and variables that can only be accessed internally (current contract or derived). The external functions that can be called from other contracts and transactions. The information flow is from the readers 14 and all information the readers 14 collect to the blockchain 24 to the manufacturer app and then back out to the third parties either via the manufacturer app in third party supplier/distributor app or it is sent out as an external communication via the web server to the third parties email address/or sent via API to their own independent servers.

In one embodiment, the rules comprise the following constraints:
Time/date based deliveries/shipments;
Location/GPS;
Product storage and its parameters;
Product handling/tampering;
Asset monitoring;
Gas token usage;
NB-IoT transmission usage;
No. of scans/independent reports from readers 14 or scanning devices.

In one example, if a defective product is not recalled before it gets to a consumer, when the consumer scan the tag, the user app will indicate that the product has been tampered with damaged etc., deactivate warranty, and issue the consumer with a refund/or activate a contract to provide a replacement immediately.

The system 10 of the present invention can ensure data integrity as every piece of supply chain data is authenticated by the signature from manufacture to the consumer over the entire transaction. The signature is generated by the data source's unique private key and therefore guarantees the sender's identity and the trustworthy of the supply chain data. All supply chain data are then secured by blockchain 24, which is a decentralized, peer-to-peer (P2P) and hash-chained ledger and guarantees the integrity of the data recorded in it. The database is updated by trusted agents according to the supply chain data secured in the blockchain 24. As a result, the supply chain data in a database for storing data in the blockchain 24. Meanwhile, the database can be periodically verified to ensure that the database has not been tampered. Compared with other structures, e.g., IoT servers collect a batch of IoT data and upload Internet of Thing (IoT) data to the blockchain, the proposed system guarantees that the data can truthfully send and recorded by IoT devices and can avoid the man in the middle attack at the IoT servers.

The present invention provides a supply chain management system that is more efficient compared with the structure that supply chain data are only stored in the blockchain. Although tamper-resistant, general blockchain systems do not support querying with keywords of the payload.

In one embodiment of the present invention, the system 10 sets an index of supply chain data using the agent and database, which is able to support various query operations with specific requirements and returns querying results in time. On the other hand, blockchain requires users to store all blockchain data to verify existing data which, however, is too heavy for many devices, e.g., mobiles and web applications.

The system 10 of the present invention does not require applications to store any data and therefore can be deployed on various devices, including mobile phones and web platforms. Meanwhile, it can verify data with arbitrary blockchain gateways to avoid the main in the middle attack and single point failure.

The system 10 of one embodiment of the present invention also provides a supply chain management that is cost efficient because the system only uses blockchain as a data warehouse and does not use expensive blockchain features, e.g., data process in smart contracts. The proposed supply chain system is also flexible because the data structure can be customized to meet different requirements.

In one embodiment of the present invention, there is provided a user app 18 for accessing the system 10. The user app 18 is adapted to trace the supply chain of a product with tags 12, and readers 14. The tag 12 can be a QR code tag, or RFID/NFC tag. The readers 14 are devices for reporting to an infrastructure 16 having a server 22 and associating with blockchain 24 in real-time via long-range Internet of Thing communication standards, such as NB-IoT or Cat-M1 or LPWAN.

The user app 18 achieves real-time traceability, accurate anti-counterfeiting and reliable traceability through the fusion of blockchain 24 and advanced intelligent sensor-based readers 14. Consumers can easily obtain a serial number, product batch and production date of a product by scanning a tag 12 (Smart tag, RFID/NFC tag, or QR code tag). The user app 18 is adapted to make the entire supply chain process traceable and transparent. By scanning the tag 12, the authenticity of the products can be confirmed via blockchain intelligence, creating a safe and secure consumer experience. The user app 18 thereby makes product logistics information real and reliable, data security is guaranteed via the blockchain component. Since scanning is quick and easy, the user app 18 allows a consumer to verify the authenticity of the product by scanning the personalized QR code NFC, RFID label or IoT device. The product traceability query can be performed by sensing the dynamic encryption password contained within the smart tag using mobile devices installed with the user app 18.

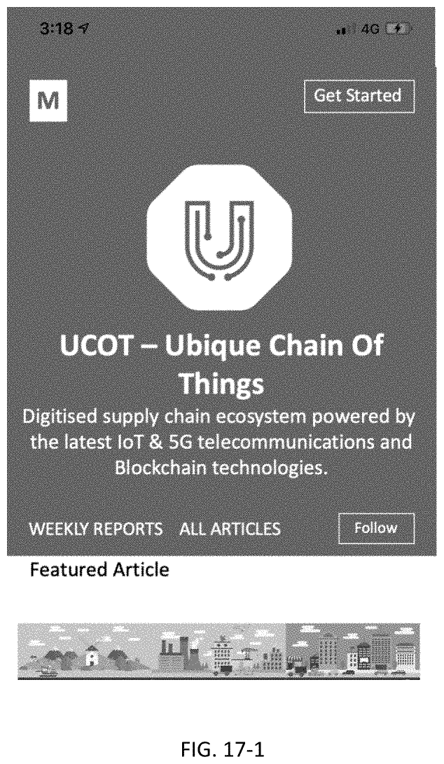

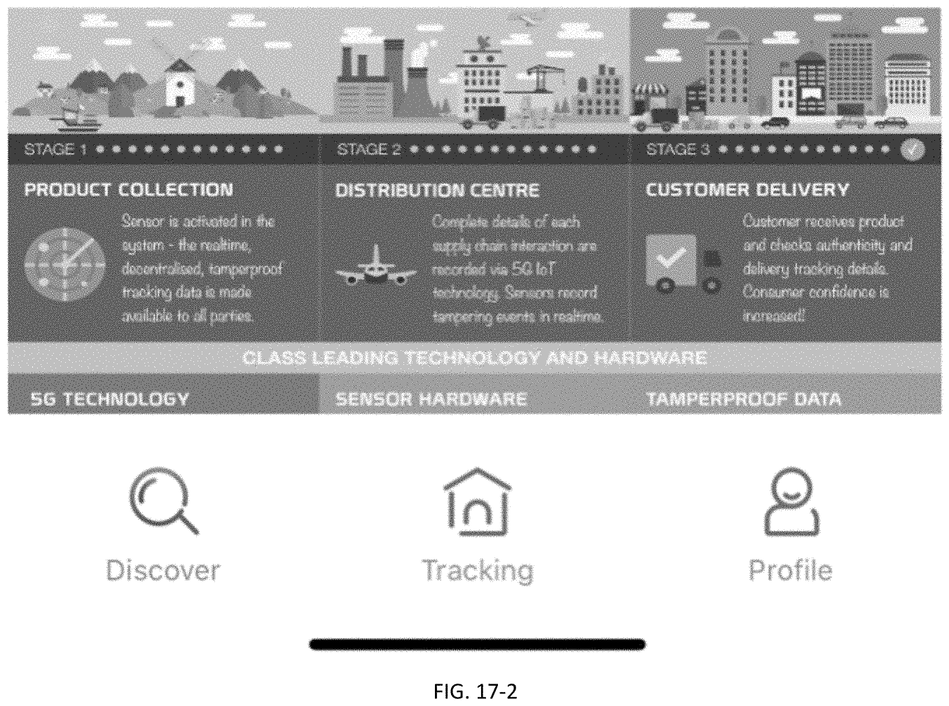

In one embodiment, the user app 18 is adapted to provide real-time updates of system related news, cutting-edge technology newsletters, blockchain product information and related business product recommendation information as shown in FIG. 17.

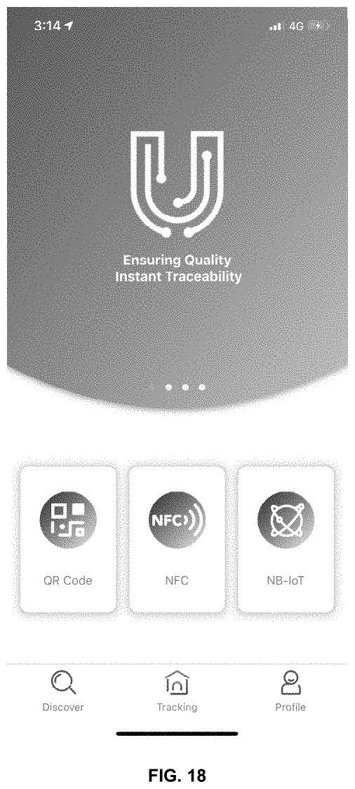

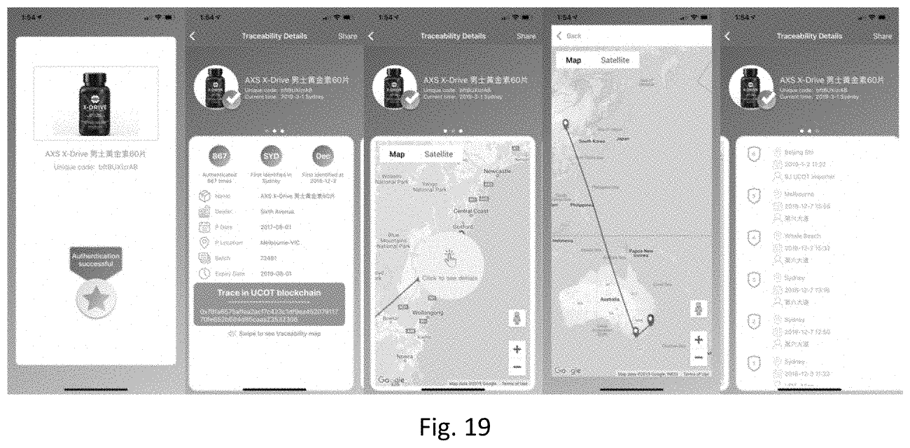

Reference is now made to FIG. 18 to FIG. 19 providing the tracking function of the user app 18 in accordance with an embodiment of the present invention. The tracking function can be initiated by scanning a QR code tag or sensing a smart tag to identify the product for tracing.

In one embodiment, the scanning interface of the user app 18 allows a customer to scan the anti-counterfeit QR code tag or other kinds of tags attached to the product for the initial identification of the product. The authentic information will include the product thumbnail, product name, manufacturer/distributor, product origin, production batch, expire date.

In another embodiment, the scanning interface of the user app 18 is adapted to sense a smart tag attached to the product storing detailed product information for tracings. The authentic tracing information will include the product thumbnail, product name, global unique code, current time position, product details interface, Number of times of authenticity, first time of authenticity, time of first time, manufacturer/distributor, place of origin, production lot, expiration time, blockchain depth traceability, product traceability map, detailed node information.

In one embodiment, a reader 14 can be used to scan the QR code containing the unique ID of the reader to track the position, temperature and other statuses of the reader device in real-time. For example, the reader 14 corresponding to the QR code (trial label) given later flew from Sydney, Australia to Melbourne in the 2018 test. Real-time upload of device location and temperature information winding via Internet of Things technology. By scanning the device ID, it is possible to see the entire flow of the device and the temperature information at different times.

In another embodiment, the user app 18 is adapted to track a product by carrying out one or more steps of:
launching user app 18 on a device, such as a desktop, laptop, or mobile device;
retrieving an identification of a product such that the authenticity of the product, the product traceability information interface will appear;
displaying product details (the information can be retrieved from the product details URL provided by the manufacturer/seller;
directing to a product tracking information interface which is adapted to display tracking information such as product name, a global unique code, current time position, number of times verified, origin, address, first—all scan times, manufacturer/distributor, date of manufacture, production batch, expiration date, real-time blockchain deep traceability record, various sensor based results e.g. temperature humidity/pressure, . . . etc.;
displaying traceability information of the products recorded on the blockchain 24;
displaying a product information map and detailed product information.

In the step of identifying the product, the scanning interface may be initiated on the user app 19 for scanning a QR code tag or barcode tag. Alternatively, the sensing interface may be initiated to verify the source of NFC tags and get more detailed information on a products journey & authentic traceability. Information on serialized NFC tags can inherit information from the readers 14 in real-time. Some smart device, such as smartphone, comprises built-in sensors such as when the smart device is moved close to the smart tag attached to the product, the result of the authenticity result will be retrieved. (If the product is counterfeit, the interface will not appear and will instead say it cannot verify a product.)

In one embodiment, the user app 18 is adapted set up and manage user profile. The user app 18 may comprise a login interface to allow a user to register, or enter a valid email address and password. In the process of registering a new user, the user app 18 will signal the server 22 to send a verification email to the registered email address of the user for verification.

The login interface is adapted to display a personal picture. The login interface allows a user to access the function of modifying personal information, including nickname, gender, date of birth, area, mobile phone number. The login interface may also comprise a link to recover from forgotten password. The login interface is adapted to direct a user to a password recovery interface to enter a registered email address. The system 10 will then automatically send a password reset email to the corresponding email (this email may be automatically classified as spam by your email/provider/client). Once received, a user can set a new password. If the setting is successful, the user may return to the login interface.

The user app 18 may comprise a traceability history interface adapted to allow a user query the list products that have been traced. The user app 18 may also comprise a link to terms of use for sharing the user app download address with others. The user app 18 may comprise a link to provides an introduction about the user app and an introduction to UCOT. The user app 18 comprises link to allow a consumer to sign up to follow the official media platforms of UCOT. The user app 18 may comprise a link to allow a consumer to send relevant feedback, including functional faults, product advice, product feedback, and more. The user app 18 may track response and follow up.

In one embodiment, the user app 18 is adapted to allow a customer to take a photo if a product looks like that it was opened or damaged and send back to the manufacturer through the user app. The user app 18 is adapted to allow the customer to send message to manufacturer customer service and report where they bought the product and what it looks like in the event that the consumer is not able to verify. The user app 18 is adapted to allow a user to post a review of a product. The user app 18 is adapted to allow customers to share their purchase with verification and review to: social media platforms/client website review section.

The user app 18 may provide a function for a user to participate in a loyalty scheme. The user app 18 may allow a customer to join client a loyalty scheme which can sit in social applications or just in the user app and have a direct link to clients existing loyalty program portal or website URL/social pages/platforms/devices. The user app 18 is adapted to allow customers can collect and manage points, get discounts, enter competitions, get updates, or get invites to product launches, get product credit, discount, prize for friend, get friend referral.

In another embodiment, the user app 18 is adapted to connect to an ecommerce store or clients online/offline store to purchase product e.g. wine tracer can connect to multiple wine vendors and the user has the ability to purchase directly through the user app via API and have products delivered or time for pickup.

In yet another embodiment, the user app 18 is adapted to generate recommendations, and price comparison based on information including but not limited to purchase history, gender, location, age, hobby using one or more artificial intelligent algorithms. The user app 18 may support group buy service where a group of customers can buy specific products together, or online shopping services, including but not limited to cart management, order management, order tracking.

The user app 18 may provide an augmented reality interface and the hologram of product/competition prize or other communication via hologram/augmented reality once scanned. The user app 18 is also adapted to run on various devices and platforms, e.g., smartwatch and glasses.

The scanning function of the user app 18 may take place via NFC reader on not just mobile devices but watches wristbands, rings/jewellery, glasses, ear piece, hand gesture etc. The user app 18 may also provide connectivity to a user's unique online key ID e.g. Scope/Inrupt, payment gateways, or manufacturer's inventory dispatch and delivery for orders made through the app.

In one embodiment, the user app 18 is adapted to provide voice/facial recognition/biometric, and/or 3D touch functions.

In another embodiment, the user app 18 is a plug-in for client's social media platforms via API and become fluid with other consumer communications in their own proprietary systems. The user app 18 may on its own or through social media platform provide message services for customers to communicate with others.

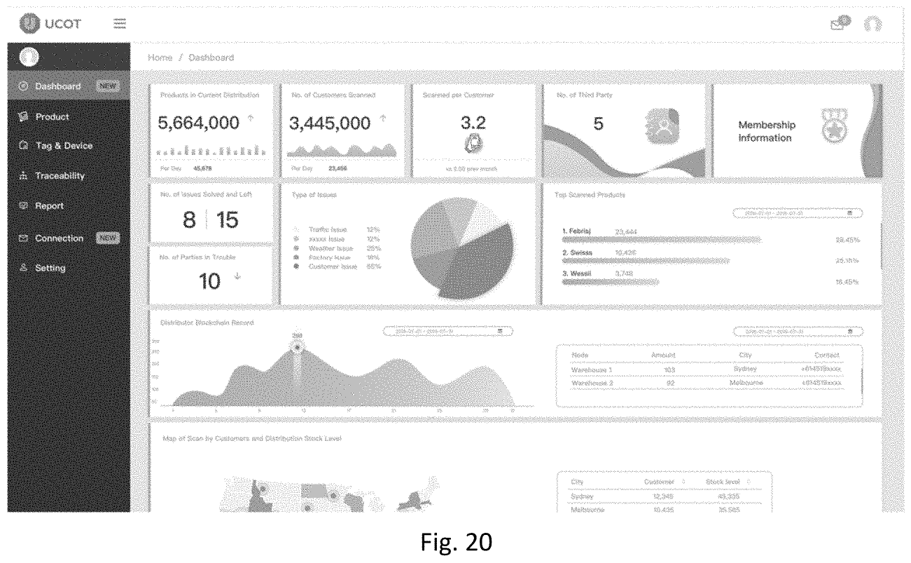

Reference is now made to FIG. 20 to FIG. 25 showing the manufacturer app interfaces. The manufacturer may view the company's product traceability overview of the manufacturer dashboard interface as shown in FIG. 20.

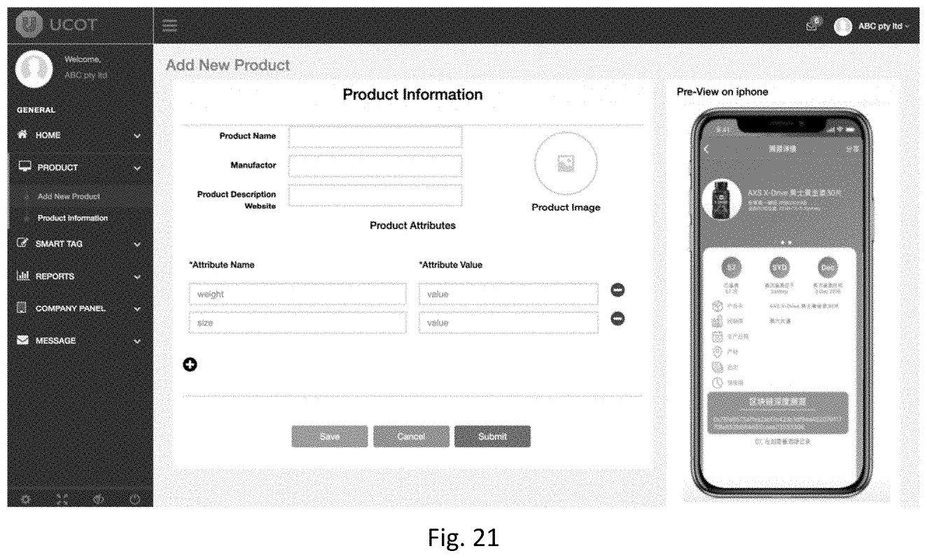

The manufacture app provides a product tab on the manufacturer dashboard interface as shown in FIG. 20 for a user to activate a product information interface as shown in FIG. 21. The manufacturer dashboard interface is adapted to allow a user to add and upload product information for displaying on the user app 18. The uploaded information includes the product name, product attributes, product manufacturer, product thumbnails, and product website link, and other customised information.

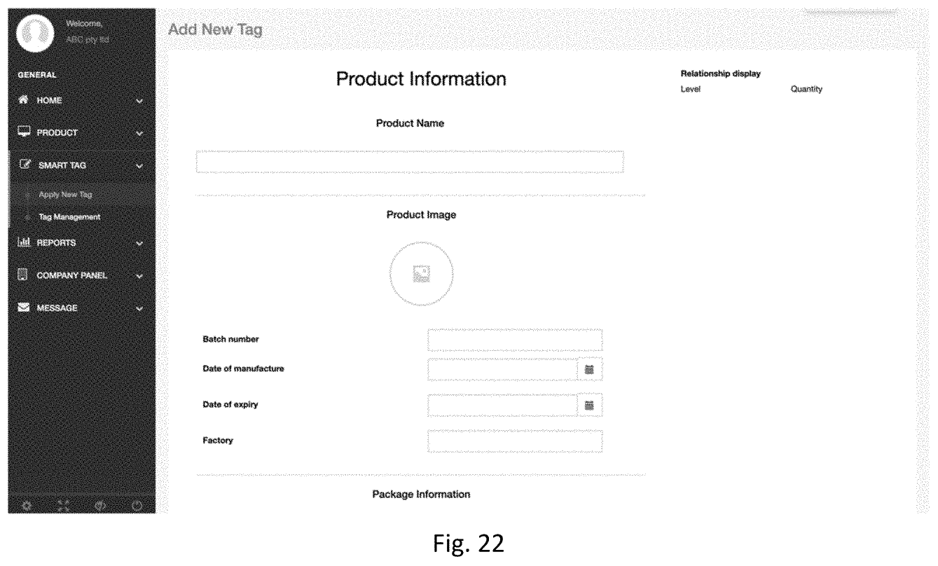

The manufacture app provides a product tab on the manufacturer dashboard interface as shown in FIG. 20 for a user to activate a smart tag interface (or known as “Tag and Device interface”) as shown in FIG. 22. The smart tag interface is adapted to allow a user to associate tags 12 with products. The tags 12 include, but not limited to, various types of tags and Internet of Thing devices. For multi-level packaging appeals, smart tags can be combined to achieve efficient traceability management.

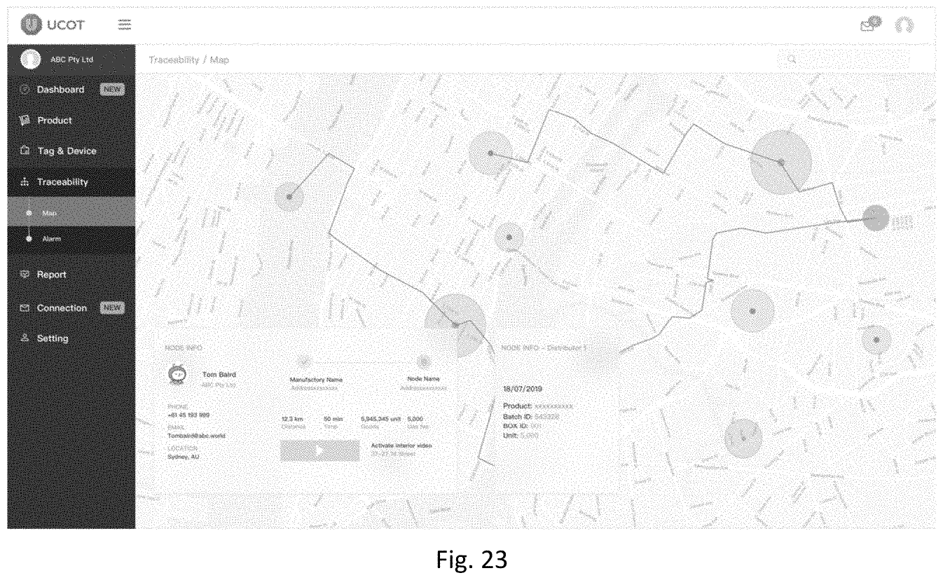

The manufacture app provides a traceability tab on the manufacturer dashboard interface as shown in FIG. 20 for a user to activate a traceability interface as shown in FIG. 23. The traceability interface is adapted to allow a user to view the checkpoints through which each product flows and the total quantity of the products which pass through the checkpoints. Visually trace the flow of the products can then be constructed. The traceability information may assist to prevent stockpiling, count the number of distributions, and help make decisions.

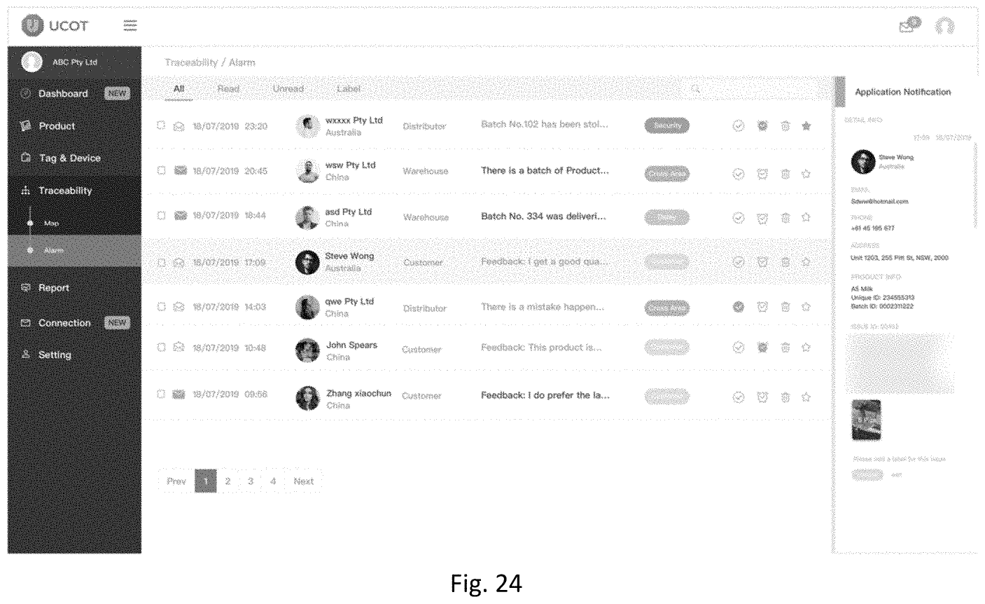

The manufacture app provides a report tab on the manufacturer dashboard interface as shown in FIG. 20 for a user to activate a report interface as shown in FIG. 24. The report interface is adapted to allow a user to analyse user and product data. The report interface is also adapted to present geographic location where the user uses the user app 18 to verify the path of the products, as well as details of the user, the way to verify the source of the product, the number of times a product has been scanned, and the time at which it was scanned.

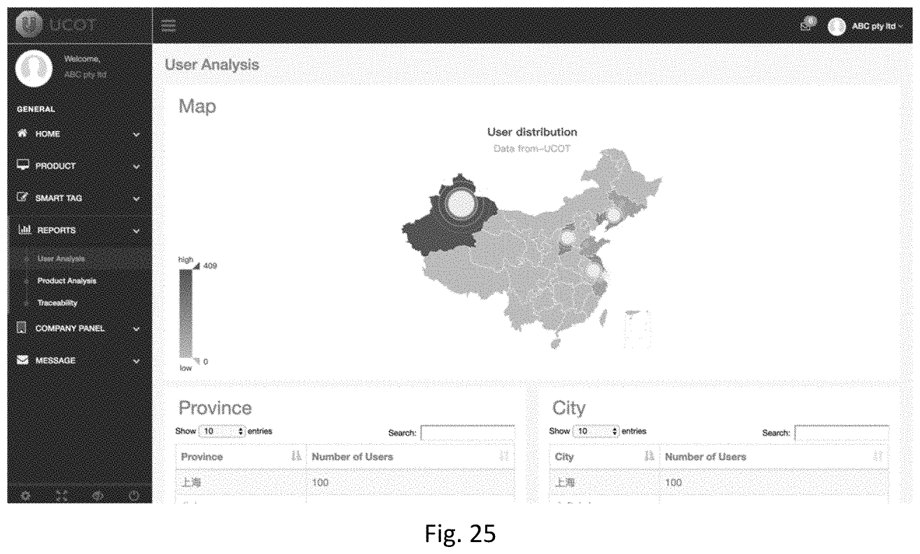

The manufacture app provides a connection tab on the manufacturer dashboard interface as shown in FIG. 20 for a user to activate a connection interface as shown in FIG. 25. The connection interface is adapted to allow a user to establish a traceability system by discovering and connecting with companies such as warehousing, logistics, distributors, retailers, etc. in this module.

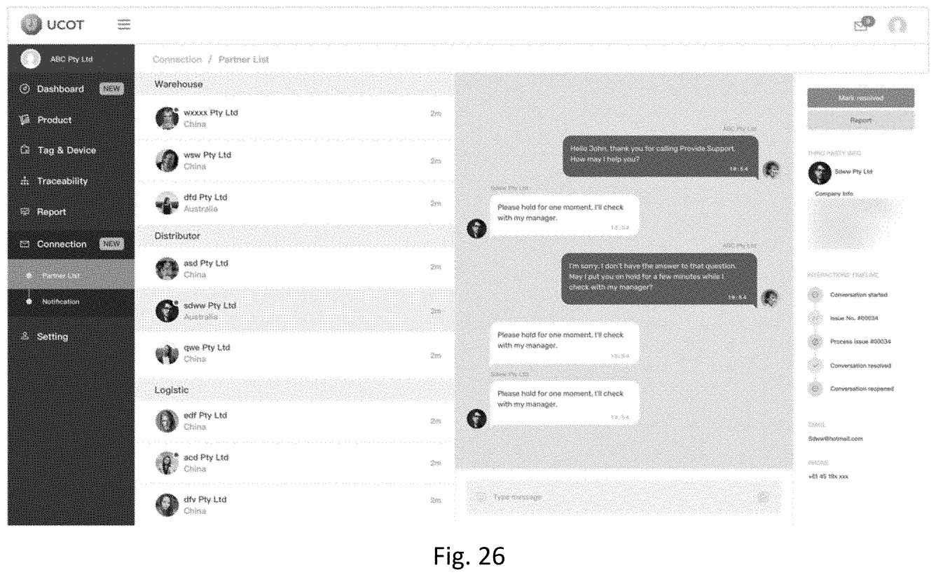

The manufacture app provides a company panel tab on the manufacturer dashboard interface for a user to activate a company panel interface as shown in FIG. 26. The company panel interface comprises includes a business information management page, a chained device management page, a node management page, an operator management page, and an invitation page.

The company panel interface is adapted to allow a user to upload the company logo, company name, company profile, contact information, website address and add the corresponding factory. The company panel interface will also display the membership period of the member who is stationed in Universal Mobile Telecommunications System (UTMS), and can be renewed by upgrading.

The Chaining Device Management Page of an embodiment of the present invention is adapted to provide the function of configuring the winding device, including the name of the organization, the name of the winding device, and the classification information. This page also shows the UTMS points used by the device (the blockchain system gas consumption).

The Node Management Page of an embodiment of the present invention is adapted to can add the node merchants (including manufacturers, distributors, warehousing, etc.) that have been stationed in the UTMS system as the product traceability node and customize the name of the node. To add a new node merchant, you can invite it on an Invitation Page and bring the other party to add the node merchant added as the product.

The Operator Management Page of an embodiment of the present invention is adapted to allow a user to add the chain node operator. The system 10 will automatically generate the QR code of the uplink device account (the account QR code can be generated repeatedly), and the node operator can log in by scanning the QR code. The chain device is responsible for performing the winding operation.

The Invitation Page of an embodiment of the present invention is adapted to allow a user to invite multiple node merchants (including manufacturers, distributors, warehousing, etc.) to enter UTMS to help improve the traceability system of the products.

In an embodiment of the present invention, there is provided a system comprising a management platform with diverse applications and uses (UTMS), a tracer (UTracer), a digital certification application (UCerti), a photo manager (UPhoto), and an IoT combination devices (UTracker).

UTMS is an enterprise management system built with IoT and blockchain enabling authenticity and traceability. UTMS integrates advanced 5G-IoT communication with blockchain technology to manage custom smart IoT devices. By using UCOT's dynamic, anti-counterfeiting smart tags for each product with UTMS, the product is digitised. The supply chain's process and journey are fully recorded and uploaded onto the blockchain. Each unit has a unique fingerprint in its smart tag and can be tracked in real-time. UTMS ensures production flow information is accurate and reliable. Data security is guaranteed. Real-time monitoring directly finds any error within the process with cross-border goods. By applying anti-counterfeiting traceability to everyday life, UTMS solves consumer trust issues from its roots and allows for complete transparency from the manufacturer to the consumer. The UTMS page is minimalistic, easy to operate and enables fast data uploading. It is the ultimate real-time truth-seeking management platform.

The tracer (UTracer) is a software application that provides an authentic traceability mobile platform built using a fusion of IoT and blockchain technology. Through the fusion of blockchain technology and advanced smart IoT devices, UTracer achieves real-time traceability with counterfeiting and reliable information. All product information can be checked via the UTracer (using NFC tags and/or QR codes) to monitor the product journey through supply chain circulation. Information and data include details about the origin, production batch, production date, traceability trajectory etc. UTracer provides convenient traceability to customers in the form of a mobile app which scans smart labels to get reliable and accurate traceability results in real time. The whole process can be traced back with each unit's unique smart label. The authenticity of the product can be traced and verified through the blockchain thus protecting the safety of the consumers.

The digital certification application (UCerti) creates a new standard for the notarisation of a variety of documents not limited to graduation certificates, official transcripts and legal documents. The contents of the certificate cannot be tampered with thus guaranteeing its authenticity. Each certificate under the UCerti program contains an NFC chip with a globally unique fingerprint. All electronic data is recorded on the blockchain for encrypted permanent storage and cannot be tampered with. In addition to the electronic data security, the chip is embedded in custom multi-layer security paper. The NFC tag differs from ordinary NFC tags in that it cannot be copied and upon physical tampering, it is destroyed. Users can verify the certificate anytime and anywhere along with other functions such as a quick and easy application for re-issuing as well as support for multiple languages.

The photograph manager (UPhoto) utilises blockchain technology so that every photo as well as its metadata (time, location etc.) is tamperproof after the initial upload. UPhoto is an authoritative tool for resource protection and dispute resolution. It is a decentralised application powered by private blockchain technology. This means that users interact directly with the blockchain, rather than relying on a third party to handle their information. Utilising the latest smart contract technology, UPhoto achieves complete verification of digital files. Upon capture, UPhoto creates a fingerprint of the digital file which is uploaded directly to the blockchain. The information once uploaded to the blockchain is non-refutable, ensuring complete security and legal merit of the electronic evidence. The characteristics of the blockchain will also ensure the user's memorable moments are recorded and preserved forever.

UTracker is a 5G-IoT combination device. The device is compact and light, and it can be monitored in real time through 5G. The device can monitor environmental factors, such as temperature, in real time. This data allows more information transparency on both ends with the traceability process being visualised which allows for new standards for transportation and storage methods. UTrackers are leading precision monitoring and real-time data-uploading IoT devices which combine M2M (machine-to-machine) communication technology with 5G. The IoT device can detect temperature, humidity, acceleration, light-intensity and other environmental information, and upload it to the blockchain of the project in real time through M2M communication technology. Thus, data support is provided for subsequent real-time analysis, intelligent decision making, and comprehensive optimisation. It also enables complete trust between stakeholders in any part of the supply chain. It can be used in coffee machines, logistics pallets, asset management, etc.

In one industrial application, the embodiment of the present invention deal with the growing demand for more transparency from brands, manufacturers, and distributors throughout the supply chain due to the increasing number of false and lost products. The consumer, most importantly, wants to know the authenticity of the product as well as other information such as the raw materials, production date and location, and the storage method and transportation process. To address this market demand, the system of the present invention uses advanced IoT technology with blockchain technology to create a smart IoT system to allow completely transparent information sharing in the supply chain system thus enabling complete product control and traceability. This authenticity and transparency have its mutual benefits for both the consumer and the manufacturer thus creating a win-win situation.

Under the smart IoT ecosystem of the present invention, UPhoto devices will be deployed on the production floor to automatically upload production information to UTMS. UPhoto is used to capture the manufacturing process and record its conditions. Smart contracts set parameters for the manufacturing process therefor if improper or erroneous operations occur, the system's alarm will be triggered. This alerts personnel to improve operation procedures and enable any emergency response plans. Additionally, images of the production process are uploaded to the blockchain so that users of the UTracer app can get a clear understanding of the product's journey and use the product with confidence.

One of the main functions of the system of the present invention is to provide traceability perception in the supply chain process. That is to be able to trace the origin of the product. This function is mainly managed by UTMS. To retrieve full product information, the manufacture is required to register onto the UTMS. Upon completion of registration and an approval process, each unit under the manufacturer receives a unique product number. Through IoT and blockchain technology, UCOT encrypts the basic information of the goods in the blockchain and gives each product a key control point which clarifies the parties responsible for each link. The UTMS also has a commodity control mode with records and traces of the production process. This mode ensures that all aspects of production, transportation, storage and distribution are transparent for each product, such that each transaction in the distributor network can be verified.

Furthermore, the condition of the goods during transit can also be monitored with the use of UTracker. By using M2M communication technology with 5G, UTracker accurate monitors environmental factors (e.g. the temperature, humidity, acceleration, light intensity) uploads this data in real-time to the blockchain. T his provides data for subsequent real-time analysis, smarter and well-informed decision-making for the optimisation of productivity as well as other supporting services.

Consumers can finally use the UTracer app with the smart label on the product packaging to retrieve basic product information and understand its journey. Consumers can then use the UCOT ecosystem to actively reflect their needs and preferences of their products.

The system of the present invention is adapted to provide product certification. The system of the present invention establishes complete transparency and authenticity by verifying products' physical attributes, evaluating the authenticity and identity, and issuing certification to protect consumers from counterfeits. It does this by collecting data from multiple parties and stakeholders and setting up automatic smart contracts. The authentication function in the system of the present invention is implemented by UCerti. Its certification functions include:
Verifying the authenticity of goods;
Quality control reports;
Certification of important documents and materials (such as graduation certificate certification).

The technical principle implemented in UCerti of an embodiment of the present invention is to use the blockchain technology to add a globally unique code and smart anti-counterfeiting chip to each certificate. Forgery is thus effectively reduced since the certificate issued by UCOT uses custom multi-layered security paper with embedded dynamic anti-counterfeiting NFC chips.

The following is a general breakdown showing how multiple industries can leverage the platform disclosed in the present invention with remodelling their supply chain process:
Manufacturers (pharmaceutical laboratories and pharmaceutical companies);
Quality control agencies;
Warehousing, logistics, dealers and retailors ;
Consumers.

The Manufacturer

In the manufacturing field, a configuration of UPhoto will monitor and record the manufacturing process and environment (temperature, pressure, etc). During production, smart contracts are programmed to set parameters so that operational data and results are immediately online. This ensures that all processes are well documented and ensures that all information is completely transparent from the very beginning of the supply chain. An emergency protocol is activated if an incident occurs in any of the links in the supply chain.

During packaging, smart labels containing a globally unique fingerprint for each unit, are placed on each product through assembly line equipment. The smart label contains all the information about the product including its environment, shelf life, production time, etc. The IoT equipment is provided for enterprises which are installed at the time of shipment and allows real-time monitoring of the products' entire journey. This data is encrypted and stored in the blockchain thus ensuring the safety of the products and reducing human error and interference. Furthermore, all this data that is collected during the supply chain process is accessible via the UTMS which makes it convenient for manufacturers to access big data reports.

For quality control process, the quality control link is crucial in the supply chain. The system of the present invention can be remodelled to support this part of the process by recording any botched or sub-standard operations and unconditionally disclosing it to the drug regulatory authorities of the respective countries. Upon serious and/or continuous breaches, the system automatically revokes the enterprise's Good Manufacturing Practices (GMP) certificate thus putting production to a halt. Thus, this system gives enterprises and brands credibility with its information transparency which will revolutionise current standards and developments in the industry.

For warehousing, logistics, dealers, retailers, the system of the present invention provides handset and tracker to provide information on warehousing and distribution operation which includes images and storage environment conditions respectively. All this data will be encrypted and stored in the blockchain. If any breach occurs, the system's alarm will be triggered immediately. Staff can access any uploaded data and monitor the whole operation on UTMS.

In a system of the present invention, Consumers can use the UTracer app to trace the source of the product and provide immediate feedback. This feedback is directly accepted by the manufacturer. Both parties can verify that the information and quality of the goods are the same on both sides. By joining a community channel, consumers can also anonymously provide information such as preferences and demographics in exchange for a more optimised and personal experience.

The present invention can also be used in other specific industry applications. The following describes modifications of the general solution for all industries and products that the system of the present invention is specifically targeting.

The system of the present invention can be used in baby formula industry. In this implementation, additional conditions can be monitored such as the humidity of the environment, the health conditions of the cows as well as the nutritional value of all the raw materials using the present system.

The system of the present invention can also be used in wine Industry. In this implementation, additional variable conditions can be monitored such as the growth of the raw materials via images as well as the conditions during the fermentation process, bottling, etc.

The system of the present invention can also be used in pharmaceutical industry. The present invention can be remodelled to provide a specific solution to the medical and pharmaceutical industry, which monitors the entire production and supply process and records data on the blockchain to prevent it from being tampered with, effectively countering counterfeit drugs on the market. For high-end drugs, it is difficult to monitor and control the transportation due to the critical conditions that the drugs must be kept in. The smart labels of the present invention can track the positioning, and can also sense the temperature, humidity, pressure and other factors to solve the pain points of the medical supply chain and ensure the quality of the medicine when it reaches the consumer. Additionally, UTMS can be connected to patients' medical records, which can be uploaded to the blockchain. This reduces incidents, medical disputes as prescriptions and records are protected from omissions and human error. Thus, data integrity and accuracy can be ensured while enhancing trust between healthcare providers and patients.

The system of the present invention can also be used in logistics Industry. The system of this present invention can be remodelled as a new generation logistics system, which is based on blockchain and IoT, can help establish a traceability system for the logistics system providing real time cargo tracking, administration reduction and increase in transparency. Blockchain technology can be also applied to air transport and maritime logistics as well as other fields such as traceable technology for shipping and integrated logistics. Through smart contracts, cargo circulation can be sped up and further reduce docking time at terminals or airports. Additionally, blockchain' s tamper-resistant characteristic can give logistics companies an edge in production and transportation. The system of the present invention can provide a new intelligent logistics solution that links the upstream and downstream of the supply chain to open a sustainable business ecosystem.

The receiving party creates an order through UTMS, and the system will open the cargo location tracking right after the payment is successful. After the goods are received, UTMS can then be used to confirm the goods have entered the inventory. They can continue to carry out inventory checks throughout the journey

After the cargo owner confirms and manages the order information through UTMS, they can select the logistics carrier company to carry out cargo transportation within the platform.

The carrier receives the shipping order through the system and assigns the order to the resident driver. Drivers who are picking up the orders can be monitored and thus reduce the idle time. Through the special smart IoT equipment, the status of the goods can be monitored in real time, reducing any risk during transit. The system provides a variety of services such as truck fuel quantity monitoring, insurance, ETA, etc., effectively reducing the administration of logistics companies.

The system of the present invention can also be used in cold chain transportation. The system of the present invention can record cargo information in real time and submits it to the blockchain through a special chip that can detect environmental factors (such as temperature, humidity and air pressure) ensuring that the data is transparent and tamper resistant. When the product is damaged due to any environmental factors, an alarm will be triggered to prevent any further losses. The party responsible for the damage/loss can also be easily held accountable. With the help of smart contracts, the equipment provided in the system of the present invention can automatically trigger an insurance claim mechanism, eliminating the need for a lengthy process of backtracking and resolving disputes in traditional operations.

Additionally, cold chain transport companies can use the transparent characteristics of blockchain technology to share their carrier capacity with other customers thus optimising the usage of cold chain logistics resources.

The system of the present invention can also be used in agricultural industry. The system of the present invention can transform agricultural production with a smart solution using IoT and blockchain technology. The system of the present invention utilises automation to increase efficiency through the IoT technology. UCOT first uses NFC, RFID and other technologies to accurately locate agricultural products such as livestock and trees. The system of the present invention implements a variety of IoT smart devices to collect agricultural production data such as moisture, temperature, humidity and light intensity.

The web console design for agricultural industry (Agricultural Console) in the system of the present invention can display data, has an alarm and warning system as well as support for third party APIs. The Agricultural Console also provides custom rules to link agricultural production data with smart agricultural equipment to automate processes such as irrigation, time lapsing, fertilisation and pest control. The IoT-blockchain smart agriculture platform of the present invention preserves agricultural production data with blockchain technology, and can reliably share all production data with both agricultural companies and consumers for transparency.

Although the invention has been described with reference to specific examples, it will be appreciated by those skilled in the art that the invention may be embodied in many other forms, in keeping with the broad principles and the spirit of the invention described herein.

The present invention and the described preferred embodiments specifically include at least one feature that is industrial applicable.

1. A method to secure supply chain data in a blockchain, wherein the method comprising the step of:
retrieving a unique identification code from a tag of a product and generating digital statuses of the product in the supply chain;
creating a transaction record comprising a payload field storing the unique identification code and the digital statuses;
generating a hash of the transaction records and then encrypting the hash with a secured key;
sending the transaction record to a node in a blockchain network, wherein the node has the transaction record verified and mine into a block for storing on a distributed ledger, thereby ensuring the transaction record tamper-resistance.

2. The method of claim 1, wherein the node is any one of a blockchain gateway or a normal node, wherein the blockchain gateway is adapted to forward the transaction record to a normal node for processing.

3. The method of claim 2, wherein the normal node is adapted to store all the blockchain data and connect to other blockchain nodes to form a peer-to-peer network.

4. The method of claim 3, wherein the blockchain networking comprises one or more block miner for storing all blockchain data and connect other blockchain nodes to form a peer-to-peer network, and wherein the block mine is adapted to receiving a transaction record, verifying the transaction records, generating a block to record on a distributed ledged in accordance with a consensus protocol, and writing the block on the distributed ledger.

5. The method of claim 4, wherein the blockchain networking comprises one or more light node adapted to store block headers and a plurality of latest blocks of the distributed ledge without all blockchain data.

6. The method of claim 1, wherein the digital statuses are generated by a reader associated with one or more sensor to measuring one or more conditions related to: time, humidity, temperature, light intensity or frequency, acceleration, pressure, location.

7. The method of claim 6, wherein the reader is associated with one or more sensor for interfacing into a packaging of a product to monitor the packaging integrity, or closure.

8. The method of claim 7, wherein the reader comprises a communication interface, a power source, a processing unit, and a controller, wherein the controller is adapted to associate with one or more sensors.

9. The method of claim 8, wherein the communication interface comprises a network stack buffer memories, analog-to-digital/digital-to-analog (AD/DA) converter, and a digital signal processing unit, such that the communication interface is adapted to support one or more network communication protocols including 802.11n, LoraWan, NB-IoT, RFID, BLE, SigFox, CAT-M1, NFC.

10. The method of claim 9, wherein the unique identification code is retrieved from a tag associated with a product, and the tag comprises any one of a one dimensional barcode label, a two dimensional barcode label, RFID tag, NFC tag, Internet of Thing tag, or a combination thereof for storing the unique identification code.

11. The method of claim 1, wherein the unique identification code is recorded in a database and stored on a tag associated with a product through a manufacturer software application.

12. The method of claim 11, wherein a tag is associated with a product during a manufacturing process of a production line of the product automatically.

13. The method of claim 12, wherein the database is adapted to store supply chain information of a product, wherein the supply chain data comprises one or more digital statuses generated by one or more readers.

14. The method of claim 13, wherein the supply chain data is mapped from the distributed ledger to a database in real-time by one or more software agents on a gateway node of a blockchain network.

15. The method of claim 14, wherein the software agents are adapted to loading rules and templates from local configuration files, remote configuration files, or databases to guide actions of the software agent, monitoring blockchain network statuses, parsing transaction records, writing and reading parsed data to and from the database.

16. The method of claim 15, wherein the database is adapted to store structured supply chain data and corresponding blockchain indexes.

17. The method of claim 16 further comprising one or more smart contracts comprising one or more condition related to the digital statuses, such that when a digital status does not satisfy a conditions, a notification will be generated and sent to a stakeholder.

18. The method of claim 17, further comprising the step of displaying tracking information by a user software application on a user device, wherein the user software application is adapted to retrieving a unique identification code from a product, compiling a tracking query of the product, sending the tracking query to a blockchain gateway, receiving transaction records from the blockchain gateway, and reconstructing a tracking history of the product.

19. A system for recording supply chain information on a distributed ledger in a peer to peer network, comprising:
one or more tags, each of which has a unique identification code corresponding to a product;
one or more readers comprising a communication interface, a power source, a processing unit, and a controller for associating with one or more sensors for generating one or more statuses;
an infrastructure comprising a server associated with a database and a blockchain network; and
one or more user software application;
wherein the readers are adapted to retrieve the identification code of the product and generate one or more status related to the product to compile a transaction record and send the transaction record to the server for uploading the transaction record to the blockchain network.

20. The system of claim 19, wherein each of the tags comprises any one of a one-dimensional barcode label, a two-dimensional barcode label, RFID tag, NFC tag, Internet of Thing tag, or a combination thereof.
